(19) United States
(12) Patent Application Publication
(10) Pub. No.: US 2025/0175234 A1
(43) Pub. Date: May 29, 2025

(54) COOPERATIVE RELAYING BY RIS AND RELAY UE

(71) Applicant: QUALCOMM Incorporated, San Diego, CA (US)

(72) Inventors: Ahmed ELSHAFIE, San Diego, CA (US); Yu ZHANG, San Diego, CA (US); Hung Dinh LY, San Diego, CA (US); Seyedkianoush HOSSEINI, San Diego, CA (US)

(21) Appl. No.: 18/841,364

(22) PCT Filed: Apr. 27, 2022
(86) PCT No.: PCT/CN2022/089482

§ 371 Date: Aug. 23, 2024

(51) Int. Cl. H04B 7/06; H04B 7/04; H04L 5/00; H04W 16/28

(52) U.S. Cl. CPC H04B 7/0695; H04B 7/04013; H04L 5/0053; H04W 16/28

(57) ABSTRACT

The apparatus may be a first network node including a UE, a base station, or a RIS. The first network node may be configured to perform a beam training procedure with a second network node, a third network node, and a fourth network node, where the second network node and the third network node are configurable to provide, between the first network node and the fourth network node, an electromagnetic radiation reflection relay service and a buffering relay service, respectively. The first network node may also be configured to transmit, based on the beam training procedure, at least one of (1) a first communication to the second network node, or a second communication to the third network node, including first information corresponding to an operational state of the second network node and an operational state of the third network node and second information destined for the fourth network node.

### CROSS-REFERENCE TO RELATED APPLICATIONS

This application for patent is a 371 of international Patent Application PCT/CN2022/089482, filed Apr. 27, 2022, which is hereby incorporated by referenced in its entirety and for all purposes.

### TECHNICAL FIELD

The present disclosure relates generally to communication systems, and more particularly, to a beam training procedure for communication between a first device and at least one user equipment (UE) using at least one reconfigurable intelligent surface (RIS) and/or at least one relay (e.g., a relay UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects of wireless communication, at least one RIS and/or at least one relay (e.g., a relay UE) may be involved in a communication between a first wireless device (e.g., a base station or a UE) and at least one UE. A method for identifying a best configuration for beamforming parameters for communicating between the first device and the at least one UE using at least one of a set of at least one RIS and a set of at least one relay device may include multiple modes of training for each of the first wireless device, the set of at least one RIS, and the set of at least one relay device. In some aspects, a signaling of a state of each device during training, and for data transmission after training, may be reduced by associating different modes of training and/or data transmission (e.g., different configurations of ON/OFF states of the first device, the set of at least one RIS, and the set of at least one relay device) with different identifiers (IDs). The IDs may then be used to signal each of the devices in set of at least one RIS and/or the set of at least one relay device a state for the device and/or a mode of operation associated with the ID.

In an aspect of the disclosure, a method, a computer-readable medium, and an apparatus are provided. The apparatus may be a first device at a UE. The first device may be a processor and/or modem at a UE or the UE itself. In some aspects, the apparatus may be a first device at a base station. The first device may be a processor and/or modem at a base station or the base station itself. The first device may be configured to transmit, to at least one second wireless device and at least one network node, at least one indication of an ON/OFF state of the at least one second wireless device and the at least one network node for a beam training procedure, the beam training procedure being associated with at least one UE, the at least one second wireless device, and the at least one network node. The first device may further be configured to perform, based on the at least one indication of the ON/OFF state, the beam training procedure with the at least one second wireless device, the at least one network node, and the at least one UE. The first device may also be configured to transmit, to the at least one UE via the at least one second wireless device or the at least one network node, or receiving, from the at least one UE via the at least one second wireless device or the at least one network node, data based on the performed beam training procedure.

In some aspects, the apparatus may be a second wireless device at a UE. The second wireless device may be a processor and/or modem at a UE or the UE itself. The second wireless device may be configured to receive, from a first device, at least one indication of an ON/OFF state of the second wireless device and at least one network node for a beam training procedure, the beam training procedure being associated with at least one UE, the second wireless device, and the at least one network node. The second wireless device may further be configured to perform, based on the at least one indication of the ON/OFF state, the beam training procedure with the first device, the at least one network node, and the at least one UE. The second wireless device may also be configured to transmit at least one of (1) data received from the first device to the at least one UE or (2) data received from the at least one UE to the first device, based on the performed beam training procedure.

The apparatus, in some aspects, may be a network node. The network node may be a processor and/or modem at a RIS and/or a RIS controller or the RIS and/or the RIS controller itself. The network node may be configured to receive, from a first device, at least one indication of an ON/OFF state of at least one second wireless device and the network node for a beam training procedure, the beam training procedure being associated with at least one UE, the at least one second wireless device, and the network node. The network node may further be configured to perform, based on the at least one indication of the ON/OFF state, the beam training procedure with the first device, the second wireless device, and the at least one UE. The network node may also be configured to configure a set of configurable elements of the network node to reflect at least one of (1) data transmitted from the first device to the at least one UE or (2) data transmitted from the at least one UE to the first device, based on the performed beam training procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4A illustrates an environment in which a blockage blocks communication from a base station to a first UE but does not block communication from the base station to a second UE.

FIG. 4B illustrates a set of network components that may be utilized to transmit data from a base station to a UE that is on an opposite side of a blockage.

FIG. 5 illustrates an example in which the RIS includes multiple subsets of multiple RIS elements.

FIG. 6A is a call flow diagram illustrating a first mode of a first phase of a beam training procedure.

FIG. 6B is a diagram illustrating a base station, a relay UE, a RIS, and a receiving UE.

FIG. 7A is a call flow diagram illustrating a second mode of a first phase of a beam training procedure.

FIG. 7B is a diagram illustrating a base station, a relay UE, a RIS, and a receiving UE.

FIG. 8A is a call flow diagram illustrating a third mode of a first phase of a beam training procedure.

FIG. 8B is a diagram illustrating a base station, a relay UE, a RIS, and a receiving UE.

FIG. 9 is a call flow diagram illustrating a first mode of a second phase of a beam training procedure involving a base station, a relay device, a RIS, and a receiving UE.

FIG. 10A illustrates a first mode of the second phase in some aspects.

FIG. 10B illustrates a second mode of the second phase in some aspects.

FIG. 10C illustrates a third mode of the second phase in some aspects.

FIG. 10D illustrates a fourth mode of the second phase in some aspects.

FIG. 11A illustrates a first set of repetitions of a first set of a first phase of the beam training procedure and a second set of repetitions of a second phase of the beam training procedure.

FIG. 11B illustrates a first set of repetitions of a first set of a first phase of the beam training procedure and a second set of repetitions of a second phase of the beam training procedure.

FIG. 12A illustrates a first set of repetitions of a first set of a first phase of the beam training procedure and a second set of repetitions of a second phase of the beam training procedure.

FIG. 12B illustrates a first set of repetitions of a first phase of the beam training procedure and a second set of repetitions of a second phase of the beam training procedure.

FIG. 13A illustrates a first set of repetitions of a first phase of the beam training procedure, a second set of repetitions of a second phase of the beam training procedure, and a third set of repetitions of the second phase of the beam training procedure.

FIG. 13B illustrates a first set of repetitions of a first phase of the beam training procedure, a second set of repetitions of a second phase of the beam training procedure, and a third set of repetitions of the second phase of the beam training procedure.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a diagram illustrating an example of a hardware implementation for an example apparatus.

FIG. 21 is a diagram illustrating an example of a hardware implementation for an example apparatus.

FIG. 22 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

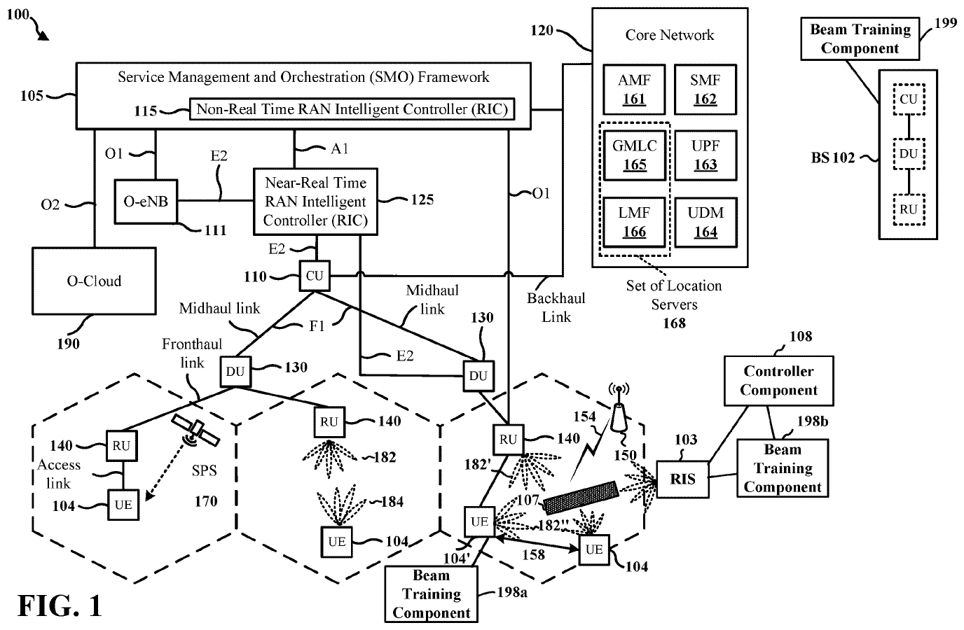

FIG. 1 is a diagram illustrating an example of a wireless communications system and an access network 100. The wireless communications system (also referred to as a wireless wide area network (WWAN)) includes base stations 102, UEs 104, an RIS 103, an Evolved Packet Core (EPC) 160, and another core network 190 (e.g., a 5G Core (5GC)). In some aspects, the RIS 103 may reflect beamformed communication between a base station and a UE to avoid a blockage 107 that blocks a directional beam between the base station 102 or 180 and the UE 104. The RIS 103 may be associated with a controller component 105. Discovery information, such as RIS capability information and/or position information for the RIS 103 may be transmitted by the controller component 105, e.g., via sidelink. The wireless communications system, in some aspects, may include one or more relay UEs 104′ for relaying data from a base station 102/180 (or another UE) to a UE 104 that is otherwise blocked by blockage 107.

The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104 (and UE 104′). Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band. The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″ (e.g., via RIS 103 and/or relay UE 104′). The UE 104 may also transmit a beamformed signal to the base station 180 (e.g., via RIS 103 and/or relay UE 104′) in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a network node including the RIS 103 and the controller component 105 may include a beam training component 198b that is configured to receive, from a first device (e.g., base station 102/180), at least one indication of an ON/OFF state of at least one second wireless device (e.g., a relay UE 104′) and the network node for a beam training procedure, the beam training procedure being associated with at least one UE, the at least one second wireless device, and the network node. The beam training component 198b may further be configured to perform, based on the at least one indication of the ON/OFF state, the beam training procedure with the first device, the second wireless device, and the at least one UE. The beam training component 198b may also be configured to configure a set of configurable elements of the network node to reflect at least one of (1) data transmitted from the first device to the at least one UE or (2) data transmitted from the at least one UE to the first device, based on the performed beam training procedure.

In certain aspects, a relay device (e.g., relay UE 104′) may include a beam training component 198a that is configured to receive, from a first device, at least one indication of an ON/OFF state of the relay device and at least one network node (e.g., including RIS 103 and controller component 105) for a beam training procedure, the beam training procedure being associated with at least one UE (e.g., UE 104), the relay device, and the at least one network node. The beam training component 198a may further be configured to perform, based on the at least one indication of the ON/OFF state, the beam training procedure with the first device, the at least one network node, and the at least one UE. The beam training component 198a may also be configured to transmit at least one of (1) data received from the first device to the at least one UE or (2) data received from the at least one UE to the first device, based on the performed beam training procedure.

In certain aspects, the base station 102/180 (or a UE 104 initiating communication with another UE 104) may include a beam training component 199 that may be configured to transmit, to at least one second wireless device (e.g., a relay device or relay UE 104′) and at least one network node (e.g., including RIS 103 and controller component 105), at least one indication of an ON/OFF state of the at least one second wireless device and the at least one network node for a beam training procedure, the beam training procedure being associated with at least one UE (e.g., UE 104), the at least one second wireless device, and the at least one network node. The beam training component 199 may further be configured to perform, based on the at least one indication of the ON/OFF state, the beam training procedure with the at least one second wireless device, the at least one network node, and the at least one UE. The beam training component 199 may also be configured to transmit, to the at least one UE via the at least one second wireless device or the at least one network node, or receiving, from the at least one UE via the at least one second wireless device or the at least one network node, data based on the performed beam training procedure. Although the following description may be focused on 5G NR, the concepts described herein may be applicable to other similar areas, such as LTE, LTE-A, CDMA, GSM, and other wireless technologies.

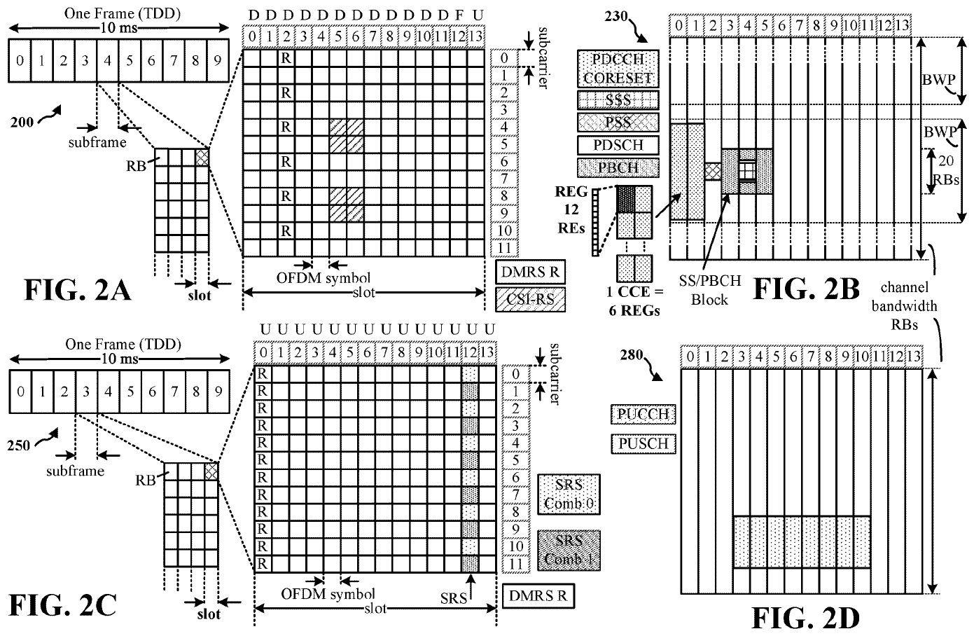

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

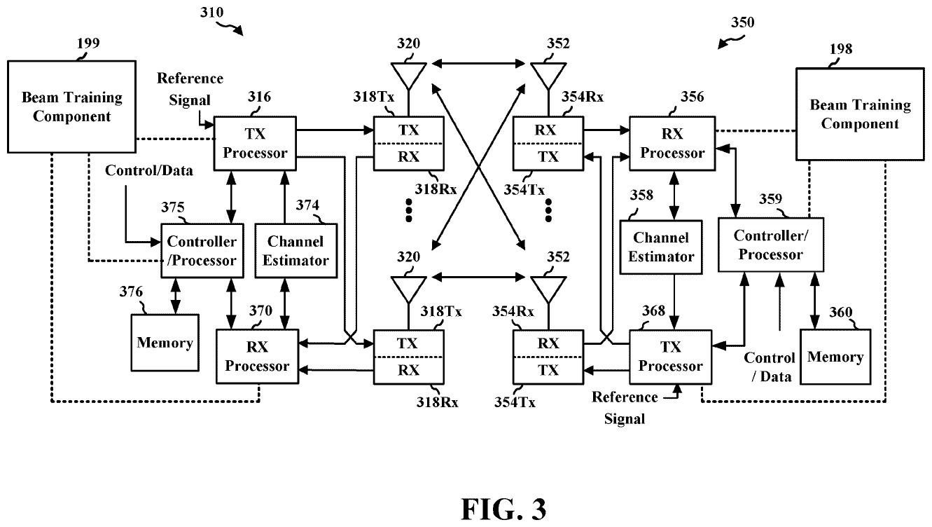

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE (or a RIS controller component) 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198a, 198b, or 199 of FIG. 1. At least one of the TX processor 316, the RX processor 370, and the controller/processor 375 may be configured to perform aspects in connection with 199 of FIG. 1.

Massive MIMO may help to increase throughput in a wireless communication system. Beamforming gain may be achieved through the use of active antenna units. Individual RF chains may be used per antenna port. The use of active antenna units (AAU) may increase power consumption. A reconfiguration intelligent surface (RIS) may be employed to extend coverage, e.g., beamformed coverage, with reduced power consumption. The RIS may include a larger number of uniformly distributed electrically controllable elements. Each RIS element may have a reconfigurable electromagnetic characteristic, e.g., a reflection coefficient. Depending on the combination of configured states of the elements, the RIS may reflect and modify the incident radio waveform in a controlled manner, such as changing a reflected direction, changing a beam width, etc. The RIS may function as a near passive device, and the reflection direction may be controlled by the base station. The RIS may reflect an impinging wave in a direction indicated by the base station to a UE.

An RIS may be deployed in wireless communication systems, including cellular systems, such as LTE, NR, etc. An RIS may alter the channel realization in a controlled manner, which may improve channel diversity. The increased diversity may provide robustness to channel blocking/fading, which may be of particular importance for millimeter wave (mmW) communication. Compared to a wireless relay or repeater systems, an RIS may be more cost and energy efficient.

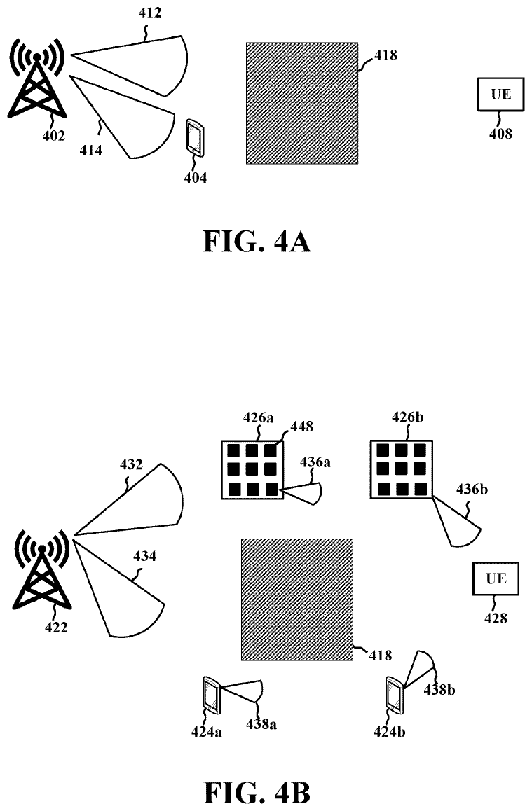

A base station may control the RIS to extend beam coverage and/or to address blockages between the base station and the UE. FIG. 4A illustrates an environment in which a blockage 418 blocks communication from a base station 402 to a UE 408 but does not block communication from the base station 402 to a UE 404. For example, FIG. 4A illustrates that a first UE 404 may be able to receive the direct transmission using a directional beam 414. FIG. 4A also illustrates a blockage 418 that blocks the directional beam 412 from reception at the second UE 408. FIG. 4B illustrates a set of network components that may be utilized to transmit data from a base station 422 to a UE 428 that is on an opposite side of a blockage 418. As illustrated in FIG. 4B, the base station 422 may transmit communication for the receiving UE 428 using a directional beam 432 (which may be referred to as the impinging beam) to the RIS 426a for reflection over a directional beam 436a to a second RIS 426b for reflection over a directional beam 436b to the UE 428. The base station 422 may indicate the directional beam 436a (or 436b) to the RIS 426a (or RIS 426b) (or a controller of the RIS 426a or 426b), and the RIS may reflect the impinging wave on directional beam 432 in the direction of the directional beam 436a (or 436b). The RIS 426a (or 426b) may adjust the reflection of the impinging beam 432 (or 436a) based on a set of coefficients, Φₐ (or Φ_{b}), indicating a set of configured states of the configurable elements 448 of the RIS 426a (or 426b).

FIG. 4B additionally illustrates that, in some aspects, a set of relay devices (e.g., UEs 424a and 424b) may be utilized to relay data from the base station 422 to the receiving UE 428 around the blockage 418. For example, the base station 422 may transmit communication for the receiving UE 428 using a directional beam 434 to the (relay) UE 424a for relay via a directional beam 438a to a second (relay) UE 424b for relay via a directional beam 438b to UE 428. A relay device may receive a transmission (e.g., via directional beam 434) and retransmit the received data (e.g., via directional beam 438a). The retransmission may be based on a decode-and-forward or amplify-and-forward relay mode. While FIG. 4B illustrates a set of two RISs 426a and 426b and two relay UEs 424a and 424b, in other aspects there may be more or fewer (or none) RISs or relay UEs.

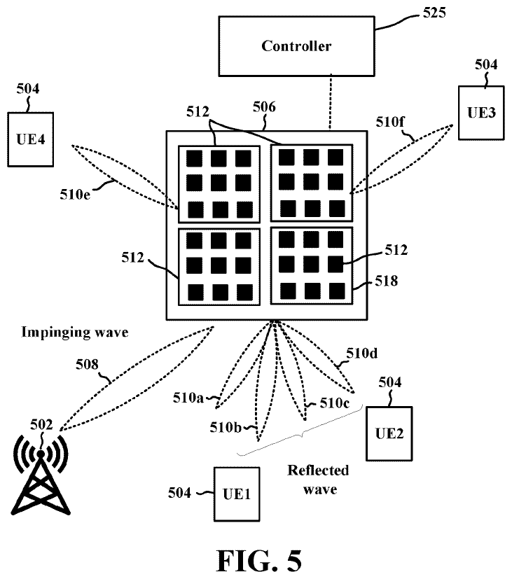

FIG. 5 illustrates an example in which the RIS 506 includes multiple subsets 512 of multiple RIS elements 518. As illustrated, different subsets 512 of RIS elements 518 may serve different UEs 504. Accordingly, the different subsets 512 of multiple RIS elements 518 may be configured differently to adjust the reflected direction, the beam width, etc. of the impinging wave 508. The RIS elements 518 may be controlled by a controller 525 at the RIS 506 based on control information received by the base station 502. As described in connection with FIG. 4, the base station 502 may indicate a beam direction (e.g., any of 510a, 510b, 510c, 510d, 510e, or 510f) to the RIS for reflecting beamformed communication received as the impinging wave 508 to a particular UE 504 in a particular direction. The RIS may similarly be controlled by a UE for reflecting communication from the UE to a base station and/or to another UE.

In some aspects of wireless communication, at least one RIS and/or at least one relay (e.g., a relay UE) may be involved in a communication between a first wireless device (e.g., a base station or a UE) and at least one UE. A method for identifying a best configuration for beamforming parameters for communicating between the first device and the at least one UE using at least one of a set of at least one RIS and a set of at least one relay device may include multiple modes of training for each of the first wireless device, the set of at least one RIS, and the set of at least one relay device. In some aspects, a signaling of a state of each device during training, and for data transmission after training, may be reduced by associating different modes of training and/or data transmission (e.g., different configurations of ON/OFF states of the first device, the set of at least one RIS, and the set of at least one relay device) with different identifiers (IDs). The IDs may then be used to signal each of the devices in set of at least one RIS and/or the set of at least one relay device a state for the device and/or a mode of operation associated with the ID.

For example, the multiple modes for training at the first wireless device that may be associated with an ID may include one or more of (1) a first mode in which the set of at least one RIS is in an OFF state, and the set of at least one relay device is in an OFF state, (2) a second mode in which the set of at least one RIS is in an ON state, and the set of at least one relay device is in an OFF state, (3) a third mode in which the set of at least one RIS is in an OFF state, and the set of at least one relay device is in an ON state, and (4) a fourth mode in which the set of at least one RIS is in an ON state, and the set of at least one relay device is in an ON state. The multiple modes for training at the at least one relay device that may be associated with an ID may include one or more of (1) a first mode in which the first device is in an OFF state and the set of at least one RIS is in an OFF state, (2) a second mode in which the first device is in an OFF state and the set of at least one RIS is in an ON state, (3) a third mode in which the first device is in an ON state and the set of at least one RIS is in an OFF state, and (4) a fourth mode in which the first device is in an ON state and the set of at least one RIS is in an ON state. The multiple modes for training at the at least one RIS that may be associated with an ID may include one or more of (1) a first mode in which the first device is in an OFF state and the set of at least one relay is in an OFF state, (2) a second mode in which the first device is in an OFF state and the set of at least one relay is in an ON state, (3) a third mode in which the first device is in an ON state and the set of at least one relay is in an OFF state, and (4) a fourth mode in which the first device is in an ON state and the set of at least one relay is in an ON state.

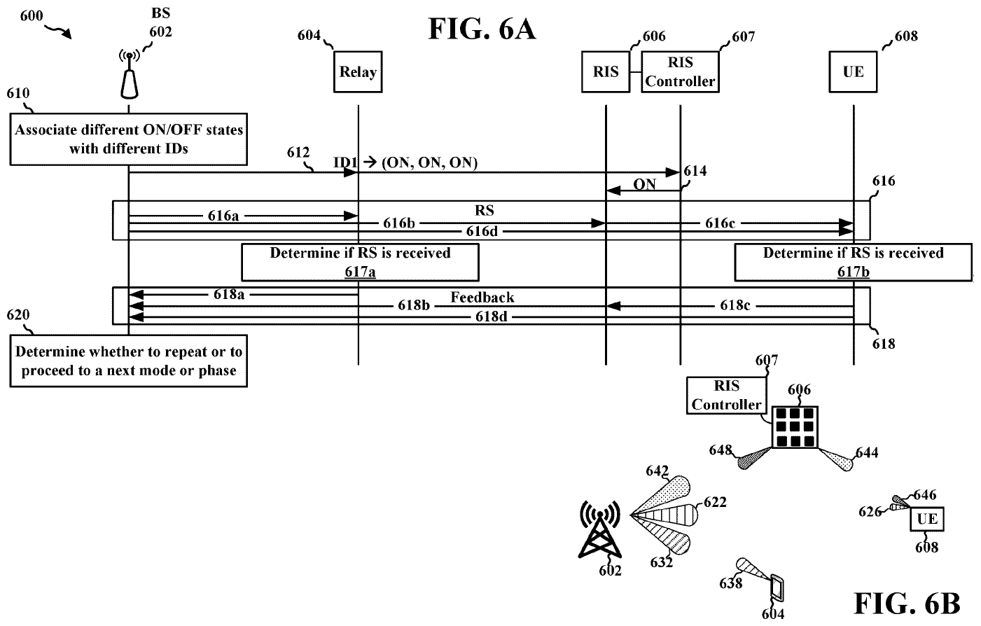

FIG. 6A is a call flow diagram 600 illustrating a first mode of a first phase of a beam training procedure. FIG. 6B is a diagram illustrating a base station 602, a relay device 604, a RIS 606, and a receiving UE 608. Diagram 600 illustrates that a base station 602 may associate 610 different ON/OFF states of devices (e.g., the base station 602, a relay device (e.g., UE) 604, and a RIS 606) with different mode IDs. A first mode ID (‘ID1’) may be associated with a state in which the base station 602, the relay device 604, and the RIS 606 are all in an ON state. The base station may transmit, and the relay device 604 and the RIS controller 607 may receive, a mode ID (‘ID1’) 612 identifying to the relay device 604 and the RIS 606 (e.g., via RIS controller 607) a mode of operation illustrated in FIG. 6B. For example, referring to FIG. 6B, the base station 602 may transmit the mode ID 612 via directional beam 632 to relay device (UE) 604 and may transmit mode ID 612 via directional beam 642 to RIS 606 (or more specifically, RIS controller 607). The RIS controller 607 may transmit (either wirelessly or through a wired connection), and RIS 606 may receive, an indication 614 for the RIS 606 to be in an ON state.

The base station 602 may transmit, and a relay device 604, a RIS 606, and a UE 608 may receive, a reference signal in a set of reference signals 616 (including reference signals 616a, 616b, 616c, and 616d). For example, referring to FIG. 6B, the base station 602 may transmit reference signal 616a via directional beam 632, reference signal 616b via directional beam 642 (to be reflected via directional beam 644), and reference signal 616d via directional beam 622. In some aspects, the set of reference signals 616 may include the ID 612 and there will not be a separate transmission of a mode ID 612.

The relay device UE 604 may buffer the transmitted reference signal 616a and determine 617a if the reference signal 616a was received. The determination 617a, may include a determination whether the reference signal 616a meets a (pre)configured threshold (e.g., a threshold reference signal received power (RSRP), received signal strength indicator (RSSI), or signal-to-interference-and-noise ratio (SINR) metric) for an amplify-and-forward (AF) relay mode. In some aspects, the determination 617a may include a determination whether the reference signal 616a was accurately received for a decode-and-forward (DF) relay mode.

The RIS 606 may reflect the reference signal 616b transmitted from the base station 602 and the UE 608 may receive the reflected reference signal 616c. The UE 608 may also receive reference signal 616d from the base station 602. Based on the reference signal 616c reflected from the RIS 606 and/or the reference signal 616d received from the base station 602, the UE 608 may determine 617b whether the reference signal 616c and/or 616d was accurately received at the UE 608.

Based on the determinations 617a and 617b, the UE 608 and the relay device 604 may transmit, and the base station 602 may receive, feedback 618. The feedback 618a from the relay device 604 may be one of a ‘good signal’ (or ‘bad signal’) indication that a reference signal 616a was (or was not) received with a metric (e.g., an RSRP, RSSI, or SINR) above a (pre)configured threshold, a HARQ-ACK (or NACK), or information regarding the received reference signal 616a (that the base station 602 may use to make determination 620 discussed below). The feedback 618b, 618c, and/or 618d from the UE 608 may include a first HARQ-ACK (or NACK) feedback related to the reference signal 616c received via (e.g., reflected from) RIS 606 and a second HARQ-ACK (or NACK) related to a reference signal 616d received from the base station 602. For example, referring to FIG. 6B, the relay device 604 may transmit feedback 618a via directional beam 638 and UE 608 may transmit feedback 618c or 618d via directional beam 646 (to be reflected via directional beam 648) and/or directional beam 626, respectively.

After receiving feedback 618, the base station 602 may determine 620 whether to proceed to a next mode or phase. For example, if both the UE 608 and the relay device 604 indicate that the reference signals 616 were received accurately (or with a metric above a threshold metric), the base station may determine to proceed to a next mode or a next phase. However, if neither the UE 608 nor the relay device 604 indicate that the reference signals 616 were received accurately (or with a metric above a threshold metric), the base station may determine to repeat a current mode (e.g., a retransmit the set of reference signals 616 or transmit a new set of reference signals via a new directional beam). Similarly, if one of the UE 608 and the relay device 604 indicates that the reference signal 616 were received accurately (or with a metric above a threshold metric) and the other indicates that the reference signal 616 was not received accurately (or with a metric above a threshold metric), the base station may determine to proceed to a next mode or a next phase or may determine to repeat the current mode.

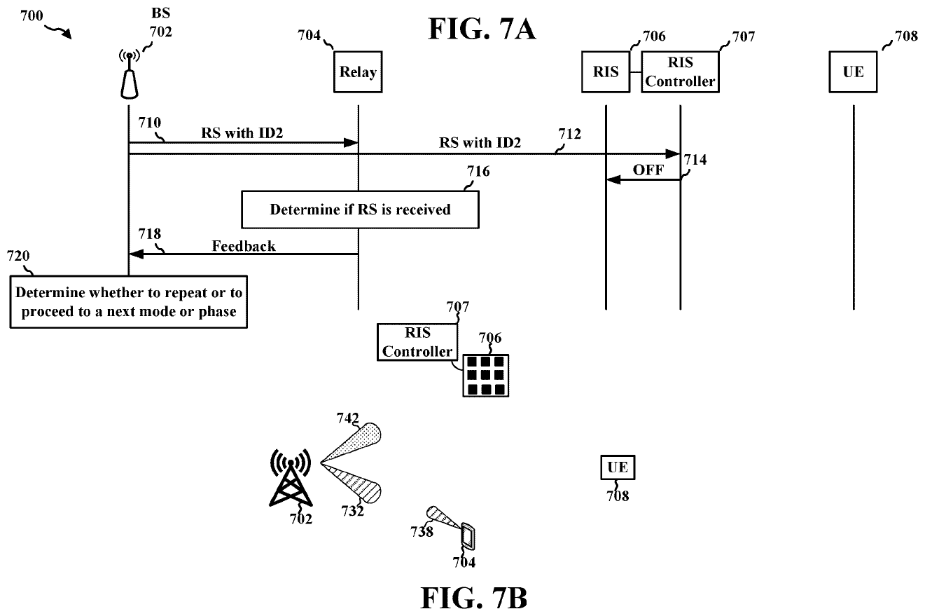

FIG. 7A is a call flow diagram 700 illustrating a second mode of a first phase of a beam training procedure. FIG. 7B is a diagram illustrating a base station 702, a relay device 704, a RIS 706, and a receiving UE 708. Diagram 700 may illustrate a second mode of the beam training procedure that follows the first mode illustrated in FIG. 6. Accordingly, the base station 702 may have already associated (at 610) different ON/OFF states of devices (e.g., the base station 702, a relay device (e.g., UE) 704, and a RIS 706) with different mode IDs. A second mode ID (‘ID2’) may be associated with a state in which the base station 702 and the relay device 704 are in an ON state and the RIS 706 is in an OFF state. The base station may transmit, and the relay device 704 may receive, a reference signal 710 including a mode ID (‘ID2’) identifying to the relay device 704 a mode of operation illustrated in FIG. 7B. The base station 702 may also transmit, and the RIS controller 707) may receive, the reference signal 712 including the mode ID (‘ID2’). For example, referring to FIG. 7B, the base station 702 may transmit the reference signal 710 including a mode ID via directional beam 732 to relay device (UE) 704 and may transmit mode ID 712 via directional beam 742 to RIS 706 (or more specifically, RIS controller 707). The RIS controller 707 may transmit (either wirelessly or through a wired connection), and RIS 706 may receive, an indication 714 for the RIS 706 to be in an OFF state.

The relay device UE 704 may buffer the transmitted reference signal 710 and determine 716 if the reference signal 710 was received. The determination 716, may include a determination whether the reference signal 710 meets a (pre)configured threshold (e.g., a threshold RSRP, RSSI, or SINR metric) for an amplify-and-forward (AF) relay mode. In some aspects, the determination 716 may include a determination whether the reference signal 710 was accurately received for a decode-and-forward (DF) relay mode.

Based on the determination 716, the relay device 704 may transmit, and the base station 702 may receive, feedback 718. The feedback 718 from the relay device 704 may be one of a ‘good signal’ (or ‘bad signal’) indication that a reference signal 710 was (or was not) received with a metric (e.g., an RSRP, RSSI, or SINR) above a (pre)configured threshold, a HARQ-ACK (or NACK), or information regarding the received reference signal 616a (that the base station 602 may use to make determination 720 discussed below). For example, referring to FIG. 7B, the relay device 704 may transmit feedback 718 via directional beam 738.

After receiving feedback 718, the base station 702 may determine 720 whether to proceed to a next mode or phase. For example, if the relay device 704 indicates that the reference signal 710 was received accurately (or with a metric above a threshold metric), the base station may determine to proceed to a next mode or a next phase. However, if the relay device 704 indicates that the reference signal 710 was not received accurately (or with a metric above a threshold metric), the base station may determine to repeat a current mode (e.g., retransmit a set of reference signals including reference signal 710 or transmit a new set of reference signals via a new directional beam).

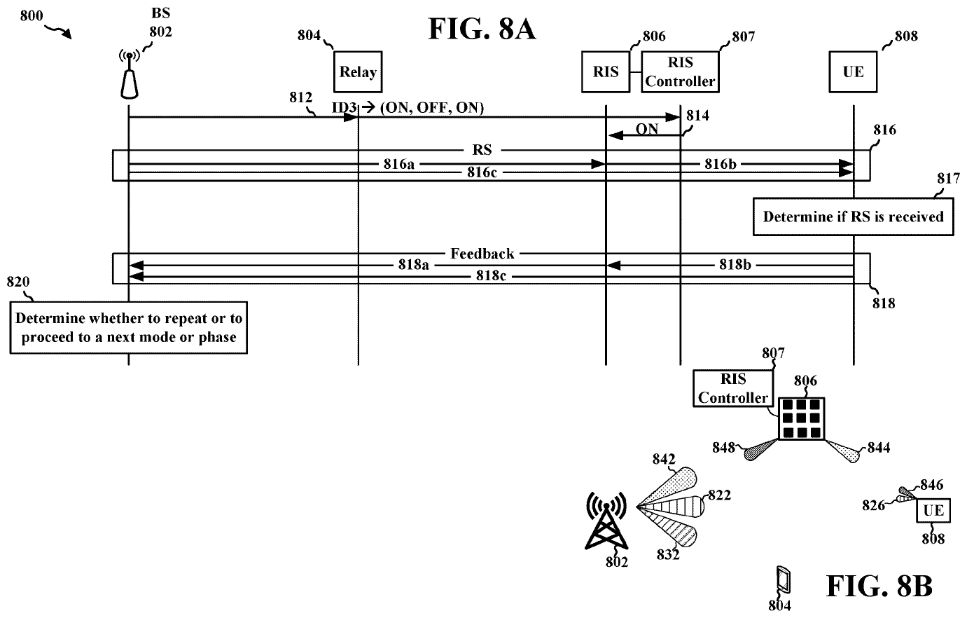

FIG. 8A is a call flow diagram 800 illustrating a third mode of a first phase of a beam training procedure. FIG. 8B is a diagram illustrating a base station 802, a relay device 804, a RIS 806, and a receiving UE 808. Diagram 800 may illustrate a third mode of the beam training procedure that follows the first mode illustrated in FIG. 6. Accordingly, the base station 802 may have already associated (at 610) different ON/OFF states of devices (e.g., the base station 802, the relay device (e.g., UE) 804, and the RIS 806) with different mode IDs. A third mode ID (‘ID3’) may be associated with a state in which the base station 802 is in an ON state, the relay device 804 is in an OFF state, and the RIS 806 is in an ON state. The base station may transmit, and the relay device 804 and the RIS controller 807 may receive, a mode ID (‘ID3’) 812 identifying to the relay device 804 and the RIS 806 (e.g., via RIS controller 807) a mode of operation illustrated in FIG. 8B. For example, referring to FIG. 8B, the base station 802 may transmit the mode ID 812 via directional beam 832 to relay device (UE) 804 and may transmit mode ID 812 via directional beam 842 to RIS 806 (or more specifically, RIS controller 807). The RIS controller 807 may transmit (either wirelessly or through a wired connection), and RIS 806 may receive, an indication 814 for the RIS 806 to be in an ON state.

The base station 802 may transmit, and a RIS 806 and a UE 808 may receive, a reference signal in a set of reference signals 816 (including reference signals 816a, 816b, and 816c). For example, referring to FIG. 8B, the base station 802 may transmit reference signal 816a via directional beam 842 (which may be reflected via directional beam 844) and reference signal 816c via directional beam 822. In some aspects, the set of reference signals 816 may include the ID 812 and there will not be a separate transmission of a mode ID 812. As opposed to the set of reference signals 616 of FIG. 6, the relay device 804 may not receive a reference signal as the mode ID 812 indicates for the relay device 804 to be in an OFF state.

The RIS 806 may reflect the reference signal 816a transmitted from the base station 802 and the UE 808 may receive the reflected reference signal 816b. The UE 808 may also receive reference signal 816c from the base station 802. Based on the reference signal 816b reflected from the RIS 806 and/or the reference signal 816c received from the base station 802, the UE 808 may determine 817 whether the reference signal 816b and/or 816c was accurately received at the UE 808.

Based on the determination 817, the UE 808 may transmit, and the base station 802 may receive, feedback 818 (including feedback 818a, 818b, and 818c). The feedback 818a, 818b, and/or 818c from the UE 808 may include a first HARQ-ACK (or NACK) feedback related to the reference signal 816b received via (e.g., reflected from) RIS 806 and a second HARQ-ACK (or NACK) related to a reference signal 816c received from the base station 802. For example, referring to FIG. 8B, the UE 808 may transmit feedback 818b or 818c via directional beam 846 (to be reflected via directional beam 848) and/or directional beam 826, respectively.

After receiving feedback 818, the base station 802 may determine 820 whether to proceed to a next mode or phase. For example, if both the feedback 818a and the feedback 818c received by the base station from the UE 808 indicate that the reference signals 816 were received accurately, the base station may determine to proceed to a next mode or a next phase. However, if neither the feedback 818a nor the feedback 818c received by the base station from the UE 808 indicate that the reference signals 816 were received accurately, the base station may determine to repeat a current mode (e.g., a retransmit the set of reference signals 816 or transmit a new set of reference signals via a new directional beam). Similarly, if one of the feedback 818a and the feedback 818c received by the base station from the UE 808 indicates that the reference signal 816 (816b or 816c) was received accurately and the other indicates that the reference signal 816 (816c or 816b) was not received accurately, the base station may determine to proceed to a next mode or a next phase or may determine to repeat the current mode.

After a first phase of the beam training procedure including one or more of the modes discussed in relation to FIGS. 6-8, a beam training procedure may transition to a second phase. The second phase may include a number of modes in which a relay device may forward a buffered reference signal or relay a reference signal. The modes may include one or more of (1) a mode in which a base station is in an ON state and a RIS is in an ON state, (2) a mode in which a base station is in an OFF state and a RIS is in an ON state, (3) a mode in which a base station is in an ON state and a RIS is in an OFF state, and (4) a mode in which a base station is in an OFF state and a RIS is in an OFF state.

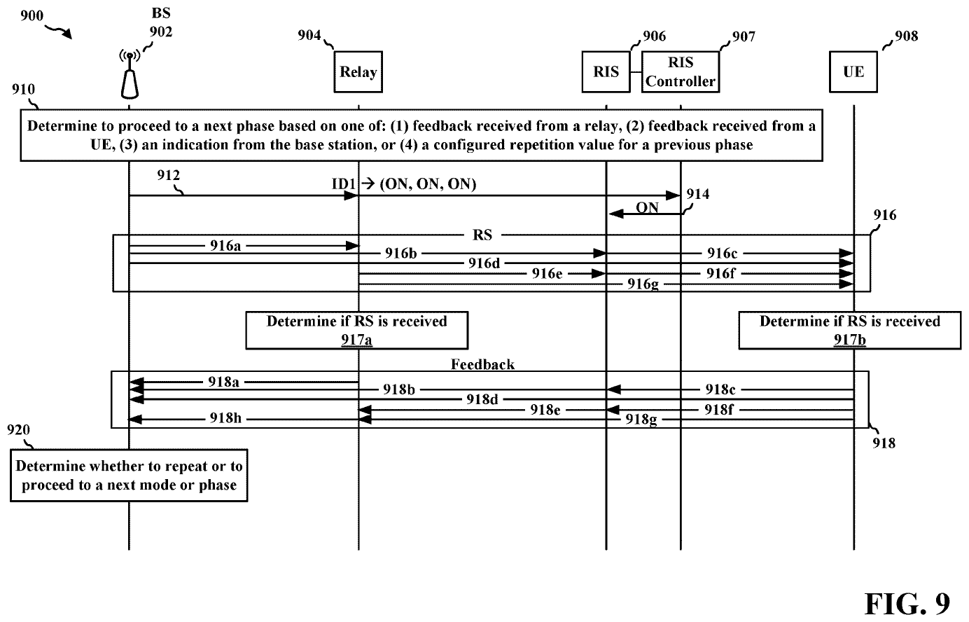

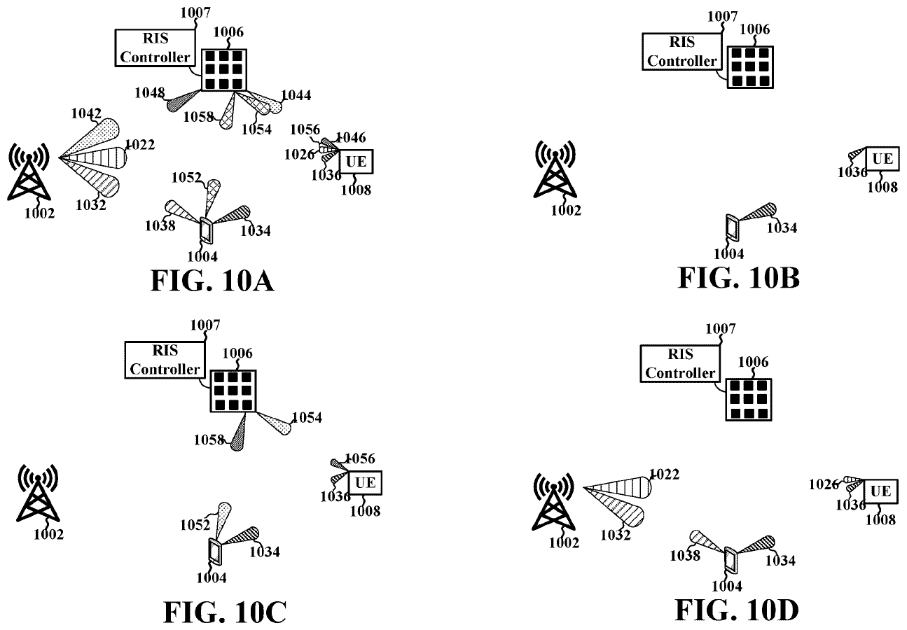

FIG. 9 is a call flow diagram 900 illustrating a first mode of a second phase of a beam training procedure involving a base station 902, a relay device 904, a RIS 906, and a receiving UE 908. FIG. 9 will be discussed in relation to FIG. 10A which illustrates a corresponding base station 1002, a relay UE 1004, a RIS 1006, and a receiving UE 1008. Diagram 900 illustrates that each of the base station 902, the relay device 904, and the RIS 906 may determine 910 to proceed to a next phase of a beam training procedure. As discussed above in relation to FIGS. 6-8, the determination may be based on feedback received from a relay or feedback received from a UE. The RIS 906 or a RIS controller 907, in some aspects, may be able to receive (and decode) feedback from the UE 908 and transition to a next phase of the beam training procedure based on receiving a positive feedback (e.g., an ACK). However, the RIS 906 or a RIS controller 907, in some aspects, may not be able to receive (and decode) feedback from the UE 908 and may transition to a next phase of the beam training procedure based on an indication received from the base station 902.

In some aspects, a beam training procedure may be configured to transition from a first phase to a second phase after a configured number of repetitions of reference signals associated with the first phase (e.g., a configured number of repetitions of the first phase) whether positive feedback is received or not. When utilizing configured repetitions, there may be no additional signaling from the base station 902 to the RIS 906 or the RIS controller 907 even when neither is capable of receiving (or decoding) feedback from the UE 908. The base station may transmit, and the relay device 904 and the RIS controller 907 may receive, a mode ID (‘ID1’) 912 identifying to the relay device 904 and the RIS 906 (e.g., via RIS controller 907) a mode of operation illustrated in FIG. 10A. For example, referring to FIG. 10A, the base station 1002 may transmit the mode ID 912 via directional beam 1032 to relay UE 1004 and may transmit mode ID 912 via directional beam 1042 to RIS 1006 (or more specifically, RIS controller 1007). The RIS controller 907 may transmit (either wirelessly or through a wired connection), and RIS 906 may receive, an indication 914 for the RIS 906 to be in an ON state.

The base station 902 may transmit, and a relay device 904, a RIS 906, and a UE 908 may receive, a reference signal in a set of reference signals 916 (including reference signals 916a, 916b, 916c, and 916d). For example, referring to FIG. 10A, the base station 1002 may transmit reference signal 916a via directional beam 1032, reference signal 916b via directional beam 1042 (to be reflected, as reference signal 916c, via directional beam 1044), and reference signal 916d via directional beam 1022. In some aspects, the set of reference signals 916 may include the ID 912 and there will not be a separate transmission of a mode ID 912. Additionally, relay device 904 may transmit, and the RIS 906 and the UE 908 may receive, reference signals 916e, 916f, and 916g in the set of reference signals 916. For example, referring to FIG. 10A, the relay UE 1004 may transmit reference signal 916e via directional beam 1052 (to be reflected, as reference signal 916f, via directional beam 1054) and reference signal 916g via directional beam 1034. The relay device UE 904 may buffer the transmitted reference signal 916a and determine 917a if the reference signal 916a was received. The determination 917a, may include a determination whether the reference signal 916a meets a (pre)configured threshold (e.g., a threshold reference signal received power (RSRP), received signal strength indicator (RSSI), or signal-to-interference-and-noise ratio (SINR) metric) for an amplify-and-forward (AF) relay mode. In some aspects, the determination 917a may include a determination whether the reference signal 916a was accurately received for a decode-and-forward (DF) relay mode.

The RIS 906 may reflect the reference signal 916b transmitted from the base station 902 and the UE 908 may receive the reflected reference signal 916c. The UE 908 may also receive reference signal 916d from the base station 902. The RIS 906 may also reflect the reference signal 916e transmitted from the relay device 904 and the UE 908 may receive the reflected reference signal 916f. The UE 908 may also receive reference signal 916g from the relay device 904. Based on the reference signals 916c and 916f reflected from the RIS 906, the reference signal 916d received from the base station 902, and/or the reference signal 916g received from the relay device 904, the UE 908 may determine 917b whether the reference signal 916c, 916d, 916f, and/or 916g was accurately received at the UE 908.

Based on the determinations 917a and 917b, the UE 908 and the relay device 904 may transmit, and the base station 902 may receive, feedback 918a, 918b, and 918d. The feedback 918a from the relay device 904 may be one of a ‘good signal’ (or ‘bad signal’) indication that a reference signal 916a was (or was not) received with a metric (e.g., an RSRP, RSSI, or SINR) above a (pre)configured threshold, a HARQ-ACK (or NACK), or information regarding the received reference signal 916a (that the base station 902 may use to make determination 920 discussed below). The feedback 918b, 918c, and/or 918d from the UE 908 may include a first HARQ-ACK (or NACK) feedback related to the reference signal 916c received via (e.g., reflected from) RIS 906 and a second HARQ-ACK (or NACK) related to a reference signal 916d received from the base station 902. For example, referring to FIG. 10A, the relay UE 1004 may transmit feedback 918a to base station 1002 via directional beam 1038 and UE 1008 may transmit feedback 918c and/or 918d to base station 1002 via directional beam 1046 (to be reflected, as feedback 918b, via directional beam 1048) and/or directional beam 1026, respectively. The UE 1008 may also transmit feedback 918f and/or 918g to relay UE 1004 via directional beam 1056 (to be reflected, as feedback 918f, via directional beam 1058) and/or via directional beam 1036.

Based on the determination 917b, the UE 908 may transmit, and the relay device 904 may receive, feedback 918e and/or 918g. The feedback 918e and/or 918g from the UE 908 may include a third HARQ-ACK (or NACK) feedback related to the reference signal 916f received via (e.g., reflected from) RIS 906 and a fourth HARQ-ACK (or NACK) related to a reference signal 916g received from the relay device 904. For example, referring to FIG. 10A, the UE 1008 may transmit feedback 918e or 918g via directional beam 1056 and/or directional beam 1036, respectively. In some aspects, the feedback may include information regarding channel quality or suitable or desired beams (e.g., beam directions) for future communication between the base station 902 and the UE 908 or between the relay device 904 and the UE 908. The suitable or desired beams may be reflected by the RIS 906 or may be received from the base station 902 or relay device 904 without reflection from the RIS 906.

After receiving feedback 918, the base station 902 may determine 920 whether to proceed to a next mode or phase. For example, if both the UE 908 and the relay device 904 indicate that the reference signals 916 were received accurately (or with a metric above a threshold metric), the base station may determine to proceed to a next mode or a next phase. However, if neither the UE 908 nor the relay device 904 indicate that the reference signals 916 were received accurately (or with a metric above a threshold metric), the base station may determine to repeat a current mode (e.g., a retransmit the set of reference signals 916 or transmit a new set of reference signals via a new directional beam). Similarly, if one of the UE 908 and the relay device 904 indicates that the reference signal 916 were received accurately (or with a metric above a threshold metric) and the other indicates that the reference signal 916 was not received accurately (or with a metric above a threshold metric), the base station may determine to proceed to a next mode or a next phase or may determine to repeat the current mode. In some aspects, the determination 920 to proceed to a next phase may be based on determining whether any suitable or desired beams (or beam directions) have been identified by the UE 908 or the relay device 904. A determination to repeat a current mode, in some aspects, may include a determination to perform a retransmission. The retransmission may be performed by (1) the relay device 904, (2) the base station 902 without involving the relay device 904, or (3) the base station 902 while the relay device continues the second phase of the beam training procedure.

FIG. 10B illustrates a second mode of the second phase in some aspects. FIG. 10B illustrates that, in the second mode, the base station 1002 and the RIS 1006 are in an OFF state while the relay UE 1004 is in an ON state. Referring to the transmissions of FIG. 9, the base station 1002 may transmit, and relay UE 1004 and RIS (and specifically RIS controller 1007) may receive, a mode ID (‘ID4’) that may be associated with a state in which the base station 1002 and the RIS 1006 are in an OFF state and the relay UE 1004 is in an ON state. Accordingly, the relay UE 1004 may transmit, and the UE 1008 may receive, one or more reference signals (e.g., reference signal 916g). The UE 1008 may determine (similar to determination 917b), based on the one or more reference signals (e.g., reference signal 916g) received from the relay UE 1004, whether the one or more reference signals was accurately received at the UE 1008.

Based on the determination, the UE 1008 may transmit, and relay UE 1004 may receive, feedback (e.g., feedback 918g). The feedback from the UE 1008 may include a HARQ-ACK (or NACK) feedback related to the reference signal received from the relay UE 1004. The relay UE 1004 may report the content of, or relay, the feedback received from the UE 1008 to the base station 1002 for the base station 1002 to determine (similar to determination 920) whether to repeat a current phase or to proceed to a next mode or phase. In some aspects, the determination to proceed to a next phase may be based on determining whether any suitable or desired beams (or beam directions) have been identified by the UE 908 or the relay device 904. A determination to repeat a current mode, in some aspects, may include a determination to perform a retransmission as discussed above in relation to FIG. 9.

FIG. 10C illustrates a third mode of the second phase in some aspects. FIG. 10C illustrates that, in the third mode, the base station 1002 is in an OFF state and the relay UE 1004 and the RIS 1006 are in an ON state. Referring to the transmissions of FIG. 9, the base station 1002 may transmit, and relay UE 1004 and RIS (and specifically RIS controller 1007) may receive, a mode ID (‘ID5’) that may be associated with a state in which the base station 1002 is in an OFF state and the relay UE 1004 and the RIS 1006 are in an ON state. Accordingly, the relay UE 1004 may transmit, and the UE 1008 may receive, one or more reference signals (e.g., reference signals 916e, 916f, and/or 916g). The UE 1008 may determine (similar to determination 917b), based on the one or more reference signals (e.g., reference signals 916e, 916f, and/or 916g) received from the relay UE 1004 (e.g., directly or via the RIS 1006), whether the one or more reference signals was accurately received at the UE 1008.

Based on the determination, the UE 1008 may transmit, and relay UE 1004 may receive, feedback (e.g., feedback 918e, 918f, and/or 918g). The feedback from the UE 1008 may include a HARQ-ACK (or NACK) feedback related to the reference signals received from the relay UE 1004 (e.g., directly or via the RIS 1006). The relay UE 1004 may report the content of, or relay, the feedback received from the UE 1008 to the base station 1002 for the base station 1002 to determine (similar to determination 920) whether to repeat a current phase or to proceed to a next mode or phase. In some aspects, the determination to proceed to a next phase may be based on determining whether any suitable or desired beams (or beam directions) have been identified by the UE 908 or the relay device 904. A determination to repeat a current mode, in some aspects, may include a determination to perform a retransmission as discussed above in relation to FIG. 9.

FIG. 10D illustrates a fourth mode of the second phase in some aspects. FIG. 10D illustrates that, in the fourth mode, the base station 1002 and the relay UE 1004 are in an ON state and the RIS 1006 is in an OFF state. Referring to the transmissions of FIG. 9, the base station 1002 may transmit, and relay UE 1004 and RIS (and specifically RIS controller 1007) may receive, a mode ID (‘ID2’) that may be associated with a state in which the RIS 1006 is in an OFF state and the base station 1002 and the relay UE 1004 are in an ON state. Accordingly, the base station 1002 and the relay UE 1004 may transmit, and the UE 1008 may receive, one or more reference signals (e.g., reference signals 916a, 916d, and/or 916g). In some aspects, the reference signal(s) transmitted by the relay UE 1004 are (buffered) reference signals relayed from the UE 1004. The UE 1008 may determine (similar to determination 917b), based on the one or more reference signals (e.g., reference signals 916a, 916d, and/or 916g) received from the base station 1002 and/or the relay UE 1004, whether the one or more reference signals was accurately received at the UE 1008.

Based on the determination, the UE 1008 may transmit, and the base station 1002 and the relay UE 1004 may receive, feedback (e.g., feedback 918d, 918e, 918f, and/or 918g). The feedback from the UE 1008 may include a HARQ-ACK (or NACK) feedback related to the reference signals received from the base station 1002 and the relay UE 1004. The relay UE 1004 may report the content of, or relay, the feedback received from the UE 1008 to the base station 1002 for the base station 1002 to determine (similar to determination 920) whether to repeat a current phase or to proceed to a next mode or phase based on the feedback received from the UE 1008 and the reported, or relayed, feedback from the relay UE 1004. In some aspects, the determination to proceed to a next phase may be based on determining whether any suitable or desired beams (or beam directions) have been identified by the UE 908 or the relay device 904. A determination to repeat a current mode, in some aspects, may include a determination to perform a retransmission as discussed above in relation to FIG. 9.

In some aspects, the base station (e.g., base station 422, 602, 702, 802, and/or 1002) is an example of a first wireless device that may also be a first UE communicating with a second UE (e.g., a UE 428, 608, 708, 808, and/or 1008). Each phase of the beam training procedure may include multiple reference signals associated with different beamforming parameters (e.g., directional beams for transmission and/or reception, beamformed signals for transmission and/or reception, RIS parameters for transmission and/or reception, etc.). For example, a beam sweeping operation may be performed to identify a set of suitable or desired beamforming parameters (e.g., a set of beamforming parameters for which a channel or reference signal is associated with a set of metrics that is suitable or desired over sets of metrics associated with other sets of beamforming parameters).

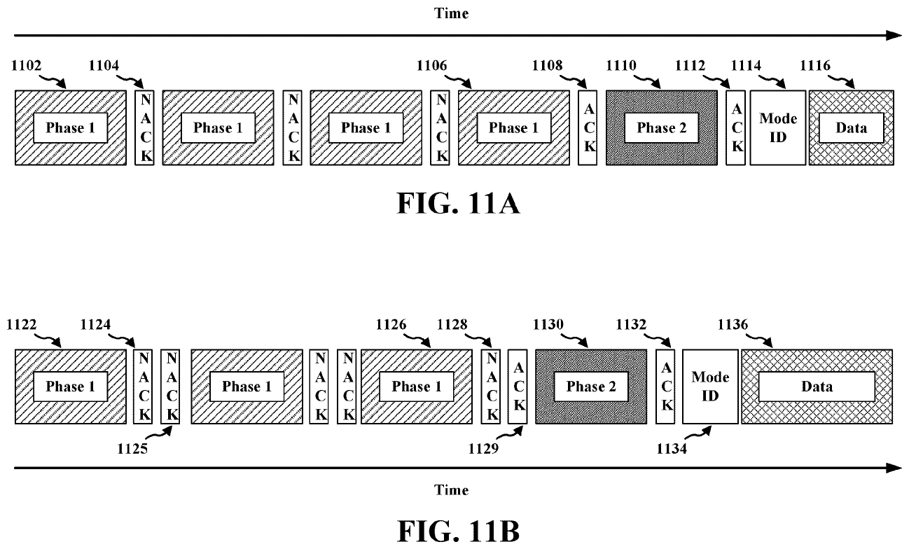

FIGS. 11A-13B illustrate different implementations of a two-phase beam training procedure as described above. FIG. 11A illustrates a first set of repetitions of a first set of a first phase of the beam training procedure and a second set of repetitions of a second phase of the beam training procedure. FIG. 11A may reflect an environment in which a base station and a RIS are in an OFF state for a first phase 1102 and a relay device is in an ON state. FIG. 11A illustrates that a first phase 1102 (e.g., as described in relation to FIGS. 6-8) of the beam training procedure may be repeated multiple times after receiving a NACK 1104 (or other negative feedback) from the relay device until an ACK feedback 1108 is received (in response to repetition 1106) at which point the beam training procedure may proceed to a second phase 1110 of the beam training procedure (e.g., as describe in relation to FIGS. 9-10D). FIG. 11A assumes that the RIS (or an associated RIS controller) can receive and decode (or otherwise identify) the ACK 1108 to identify that the beam training procedure proceeds to the second phase of the beam training procedure. After receiving an ACK 1112 (or other positive response) from a UE (e.g., UE 608, 708, 808, 908, or 1008), the base station (or other first device) may proceed to a data transmission mode. The base station may transmit a mode ID 1114 and begin transmitting data 1116 based on the configuration (e.g., the ON/OFF state of the network elements such as a set of one or more RISs or a set of one or relay devices) identified by the mode ID 1114.

FIG. 11B illustrates a first set of repetitions of a first set of a first phase of the beam training procedure and a second set of repetitions of a second phase of the beam training procedure. FIG. 11B may reflect an environment in which a base station, a RIS, and a relay device are in an ON state during a first phase 1122. FIG. 11B illustrates that a first phase 1122 (e.g., as described in relation to FIGS. 6-8) of the beam training procedure may be repeated multiple times after receiving a set of NACKs 1124 and 1125 (or other negative feedback) from the relay device and the UE until a set of feedback including at least one ACK feedback 1129 (even if the other feedback is NACK 1128) is received (in response to repetition 1126) from at least one of the relay device of the UE, at which point the beam training procedure may proceed to a second phase 1130 of the beam training procedure (e.g., as describe in relation to FIGS. 9-10D). FIG. 11B assumes that the RIS (or an associated RIS controller) can receive and decode (or otherwise identify) the ACK 1129 to identify that the beam training procedure proceeds to the second phase of the beam training procedure.

After receiving an ACK 1132 (or other positive response) relating to a second phase 1130 from a UE (e.g., UE 608, 708, 808, 908, or 1008), the base station (or other first device) may proceed to a data transmission mode. The base station may transmit a mode ID 1134 and begin transmitting data 1136 based on the configuration (e.g., the ON/OFF state of the network elements such as a set of one or more RISs or a set of one or relay devices) identified by the mode ID 1134. The mode ID 1114 and/or 1134 may be selected based on an indication received from the UE and the relay device as to a suitable or desired configuration. The mode ID 1114 and/or 1134 may further be associated with a particular set of beamforming parameters at each of the base station/first device, the relay device, the RIS, and the UE.

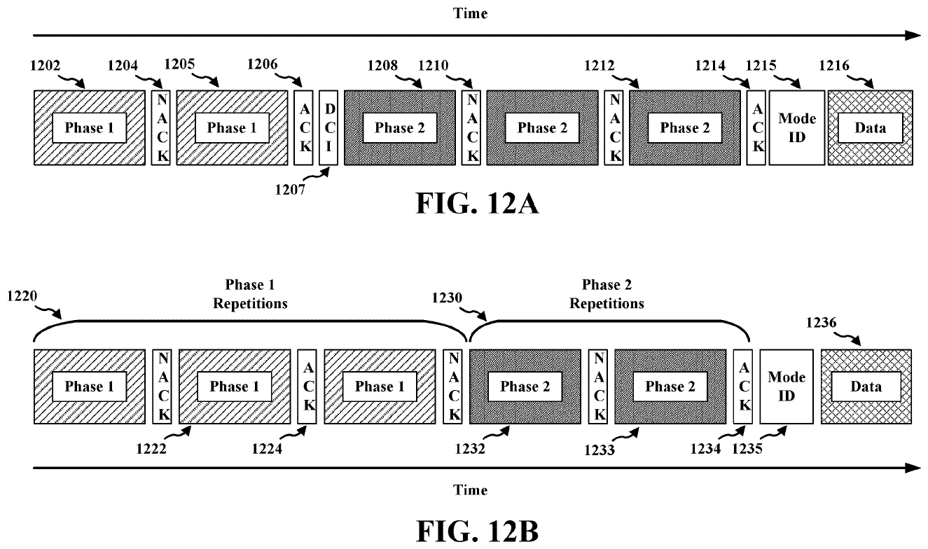

FIG. 12A illustrates a first set of repetitions of a first set of a first phase of the beam training procedure and a second set of repetitions of a second phase of the beam training procedure. FIG. 12A may reflect an environment in which a base station and a RIS are in an OFF state for a first phase 1202 and a relay device is in an ON state. FIG. 12A illustrates that a first phase 1202 (e.g., as described in relation to FIGS. 6-8) of the beam training procedure may be repeated multiple times after receiving a NACK 1204 (or other negative feedback) from the relay device until an ACK 1206 is received (in response to a first phase repetition, first phase 1205) at which point the beam training procedure may proceed to a second phase 1208 of the beam training procedure (e.g., as describe in relation to FIGS. 9-10D). FIG. 12A assumes that the RIS (or an associated RIS controller) is not able to receive and decode (or otherwise identify) the ACK 1206 to identify that the beam training procedure proceeds to the second phase of the beam training procedure. Accordingly, downlink control information (DCI) 1207 (or other control information) may be transmitted by a base station to the RIS (or RIS controller) to indicate to the RIS to proceed to a second phase of the beam training procedure. The transmission may be through a wired and/or a wireless communication link.

The base station may receive a NACK 1210 from a UE (e.g., UE 608, 708, 808, 908, or 1008) in response to the second phase 1208 of the beam training procedure. The second phase of the beam training procedure may be repeated until the second phase 1212 that is followed by an ACK 1214 (or other positive feedback). After receiving the ACK 1214 from the UE, the base station (or other first device) may proceed to a data transmission mode. The base station may transmit a mode ID 1215 and begin transmitting data 1216 based on the configuration (e.g., the ON/OFF state of the network elements such as a set of one or more RISs or a set of one or relay devices) identified by the mode ID 1215. The mode ID 1215 may further be associated with a particular set of beamforming parameters at each of the base station/first device, the relay device, the RIS, and the UE identified as being in an ON state by the mode ID 1215.

FIG. 12B illustrates a first set of repetitions 1220 of a first phase of the beam training procedure and a second set of repetitions 1230 of a second phase of the beam training procedure. FIG. 12B may reflect an environment in which a base station and a RIS are in an OFF state, and a relay device is in an ON state during a first set of repetitions 1220 of a first phase of the beam training procedure. FIG. 12B illustrates that a first phase 1222 (e.g., as described in relation to FIGS. 6-8) of the beam training procedure may be repeated a configured number of times before proceeding to a second phase 1232 which may also repeat a configured number of times. FIG. 12B illustrates that feedback (e.g., ACK 1224 and ACK 1234) may be received after each repetition of the first phase (e.g., after the first phase 1222) and after each repetition of the second phase (e.g., after the second phase 1232 and 1233). FIG. 12B illustrates that if the feedback for each set of repetitions for each phase includes at least one ACK (e.g., ACK 1224 for the first phase, and ACK 1234 for the second phase) the beam training procedure may end after the configured number of repetitions of the first and second phases of the beam training procedure. After the beam training procedure ends, the base station may proceed to a data transmission mode. The base station may transmit a mode ID 1235 and begin transmitting data 1236 based on the configuration (e.g., the ON/OFF state of the network elements such as a set of one or more RISs or a set of one or relay devices) identified by the mode ID 1235. The mode ID 1235 may be selected based on an indication received from the UE and the relay device as to a suitable or desired configuration. The mode ID 1235 may further be associated with a particular set of beamforming parameters at each of the base station/first device, the relay device, the RIS, and the UE.

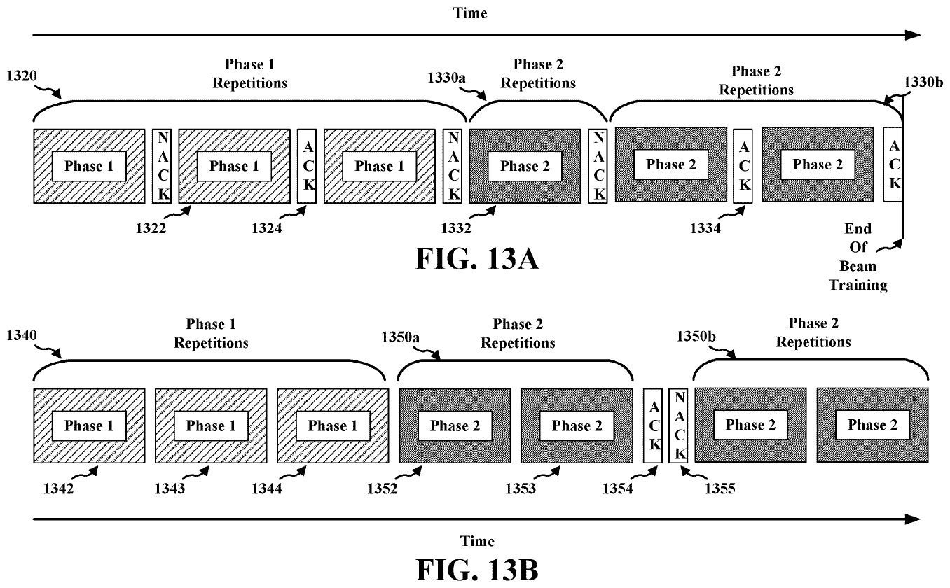

FIG. 13A illustrates a first set of repetitions 1320 of a first phase of the beam training procedure, a second set of repetitions 1330a of a second phase of the beam training procedure, and a third set of repetitions 1330b of the second phase of the beam training procedure. FIG. 13A may reflect an environment in which a base station and a RIS are in an OFF state, and a relay device is in an ON state during a first set of repetitions 1320 of a first phase of the beam training procedure. FIG. 13A illustrates that a first phase (e.g., as described in relation to FIGS. 6-8) of the beam training procedure may be repeated a configured number of times before proceeding to a second phase 1332 which may also repeat a configured number of times (e.g., one repetition in the second set of repetitions 1330a). FIG. 13A illustrates that feedback (e.g., ACK 1324 and ACK 1334) may be received after each repetition of the first phase (e.g., after the first phase 1322) and after each repetition of the second phase (e.g., after the second phase 1332). FIG. 13A illustrates that if the feedback for the first phase includes at least one ACK (e.g., ACK 1324 for the first phase) but the feedback for the second phase 1332 of the beam training procedure is a NACK, the beam training procedure determine to perform a third set of repetitions 1330b of the second phase of the beam training procedure while not repeating a first phase. The third set of repetitions 1330b of the second phase of the beam training procedure may include a different (e.g., larger or smaller) number of repetitions than the second set of repetitions 1330a of the second phase of the beam training procedure. After the third set of repetitions 1330b of the second phase of the beam training procedure, the base station may determine that at least one ACK (e.g., ACK 1334) was received and terminate the beam training procedure. After the beam training procedure ends, the base station may proceed to a data transmission mode. The base station may transmit a mode ID and begin transmitting data based on the configuration (e.g., the ON/OFF state of the network elements such as a set of one or more RISs or a set of one or relay devices) identified by the mode ID. The mode ID may be selected based on an indication received from the UE and the relay device as to a suitable or desired configuration. The mode ID may further be associated with a particular set of beamforming parameters at each of the base station/first device, the relay device, the RIS, and the UE.

Although FIG. 13B illustrates that the third set of repetitions 1330b of the second phase of the beam training procedure is associated with at least one ACK (e.g., ACK 1334) and the beam training procedure ends after the third set of repetitions 1330b of the second phase of the beam training procedure, additional sets of repetitions of the first or second phase may be performed if no ACKs are received with a particular set of repetitions of either the first or second phase of the beam training procedure.

FIG. 13B illustrates a first set of repetitions 1340 of a first phase of the beam training procedure, a second set of repetitions 1350a of a second phase of the beam training procedure, and a third set of repetitions 1350b of the second phase of the beam training procedure. FIG. 13B may reflect an environment in which a base station and a RIS are in an OFF state, and a relay device is in an ON state during a first set of repetitions 1340 of a first phase of the beam training procedure. FIG. 13B illustrates that a first phase (e.g., as described in relation to FIGS. 6-8) of the beam training procedure may be repeated a configured number of times before proceeding to a second phase 1352 which may also repeat a configured number of times (e.g., one repetition in the second set of repetitions 1350a). FIG. 13B illustrates that feedback (e.g., ACK 1354 or NACK 1355) may be received after the first set of repetitions 1340 (including repetitions of the first phase 1342, 1343, and 1344) and the second set of repetitions 1350a (including repetitions of the second phase 1352 and 1353) are complete. FIG. 13B illustrates that if one or more of the first phase repetitions (or reference signals in a first phase) is accurately received (or received with a metric that is above a threshold value for the metric) the feedback for the first set of repetitions 1340 of the first phase may include an ACK 1354. If one or more of the second phase repetitions (or reference signals in a second phase) is not accurately received the feedback for second set of repetitions 1350a of a second phase of the beam training procedure may include a NACK 1355. Based on receiving the ACK 1354 related to the first phase of the beam training procedure and receiving the NACK 1355, the beam training procedure may determine to perform a third set of repetitions 1350b of the second phase of the beam training procedure while not repeating a first phase. The third set of repetitions 1350b of the second phase of the beam training procedure may include a same number of repetitions as the second set of repetitions 1350a of the second phase of the beam training procedure. After the third set of repetitions 1350b of the second phase of the beam training procedure, the base station may receive an ACK or a NACK relating to the third set of repetitions 1350b of the second phase of the beam training procedure and determine to either repeat the second phase again with a same (or different) number of repetitions (if a NACK was received) or end the beam training procedure (if an ACK was received). After the beam training procedure ends, the base station may proceed to a data transmission mode. The base station may transmit a mode ID and begin transmitting data based on the configuration (e.g., the ON/OFF state of the network elements such as a set of one or more RISs or a set of one or relay devices) identified by the mode ID. The mode ID may be selected based on an indication received from the UE and the relay device as to a suitable or desired configuration. The mode ID may further be associated with a particular set of beamforming parameters at each of the base station/first device, the relay device, the RIS, and the UE.

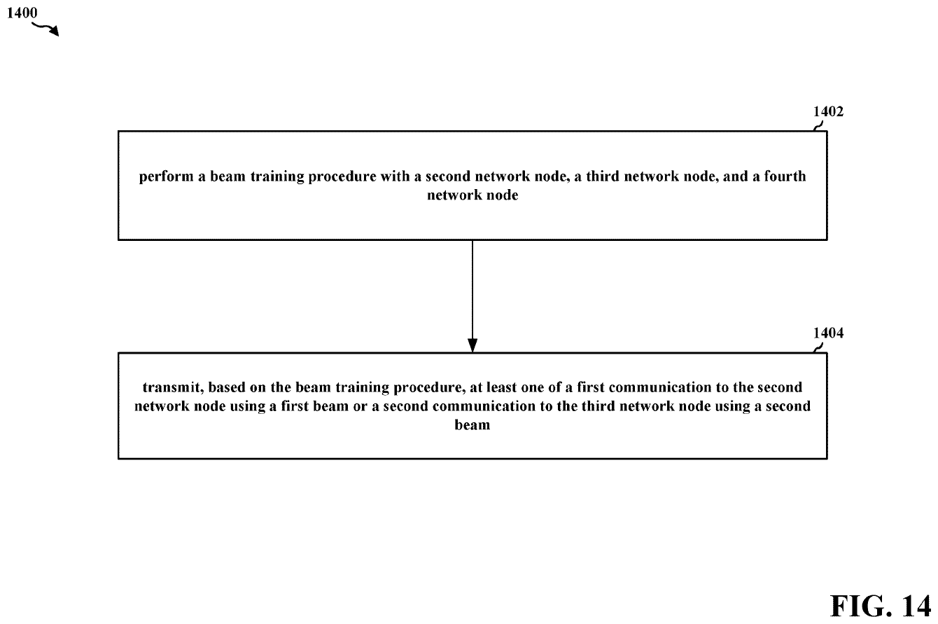

FIG. 14 is a flowchart 1400 of a method of wireless communication. The method may be performed by a first device (e.g., the base station 102/180, 602, 702, 802, and 1002; the apparatus 2202; the apparatus 2002). At 1402, the first device (e.g., a base station or UE) may transmit, to at least one second wireless device (e.g., a relay UE) and at least one network node (e.g., a RIS and RIS controller), at least one indication of an ON/OFF state of the at least one second wireless device and the at least one network node for a beam training procedure. The beam training procedure may be associated with at least one UE (a receiving UE), the at least one second wireless device, and the at least one network node. In some aspects, the at least one indication of the ON/OFF state further indicates an ON/OFF state of the first device. Each ON/OFF state of the at least one second wireless device and the at least one network node for the beam training procedure (and/or the first device), in some aspects, is associated with one of a set of mode IDs for the beam training procedure. For example, referring to FIGS. 6A, 7A, 8A, and 9, the base station 602, 702, 802, and/or 902 may transmit a mode ID 612, ID in reference signal 710, ID 812, and/or ID 912 to one or more of a relay device 604, 704, 804, 904 and a RIS controller 607, 707, 807, and/or 907. For example, 1402 may be performed by a mode identifier component 2040 or 2240.

At 1404, the first device may perform, based on the at least one indication of the ON/OFF state, the beam training procedure with the at least one second wireless device, the at least one network node, and the at least one UE. For example, 1404 may be performed by beam training component 2042 or 2242. Performing the beam training, in some aspects, includes performing two phases of beam training. For example, the beam training procedure may include a first phase in which the first device transmits a first set of transmissions to the at least one second device based on a transmitted first indication that the at least one second device is ON and that the at least one network node is OFF. For example, referring to FIGS. 7A and 7B, the base station 702 may transmit, and relay device 704 may receive, a reference signal 710 that includes a mode ID (ID2) indicating that the relay device 704 is in an ON state and that a RIS 706 is in an OFF state. The first phase of the beam training procedure may further include receiving a feedback from the at least one second device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, (4) an indication that the at least one second device received at least one transmission in the first set of transmissions with a measured characteristic that is below a threshold value, or (5) information relating to at least one transmission in the first set of transmissions. For example, referring to FIGS. 7A and 7B, the base station 702 may receive feedback 718 from relay device 704.

In some aspects, the first phase of the beam training procedure also includes the first device transmitting a second set of transmissions to the at least one UE via the at least one network node based on a transmitted second indication that the at least one second device is OFF and that the at least one network node is ON. The first device may also transmit at least a subset of the second set of transmissions to the at least one UE not via the at least one network node (e.g., directly). For example, referring to FIGS. 8A and 8B, the base station 802 may transmit a mode ID 812 to relay device 804 and to RIS controller 707 indicating that the relay device 804 is in an OFF state and that the RIS is in an ON state. The base station 802 may also transmit a set of reference signals 816a and/or 816c to the UE 808 via the RIS 806 and directly. The first device may receive a feedback from the at least one UE, where the feedback includes at least one of (1) an ACK associated with at least one transmission in the second set of transmissions and (2) a NACK associated with at least one transmission in the second set of transmissions. For example, referring to FIGS. 8A and 8B, the base station 802 may receive feedback 818a and/or 818c including one of an ACK or a NACK from UE 808 (either directly or via RIS 806).

The first phase of the beam training procedure, in some aspects, may include a first number of repetitions of the first set of transmissions and the second set of transmissions. In some aspects, the first set of transmissions and the second set of transmissions may be configured to repeat a different number of times. The first phase of the beam training procedure, in some aspects, may include repeating the first phase of the beam training procedure until a particular feedback is received from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission. In some aspects, a network node (e.g., a RIS, or RIS controller) may not be able to identify that the particular feedback has been transmitted and/or received and the first device may transmit an indication to the at least one network node relating to the ACK to instruct the at least one network node to proceed to the second phase of the beam training procedure. The indication to instruct the at least one network node to proceed to the second phase of the beam training procedure may be transmitted wirelessly or through a wired connection depending on the capabilities of the network node.

The second phase of the beam training procedure, in some aspects, may include a third set of transmissions that may be transmitted by the at least one second device to the at least one UE. For example, referring to FIGS. 9 and 10A-10D, the relay UE 1004 may transmit reference signals 916e and/or 916g to the UE 1008 (directly or via RIS 1006). The first device may receive feedback related to the third set of transmissions transmitted in the second phase of the beam training procedure. The third set of transmissions may be associated with one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the base station 1002 may receive one or more of feedback 918a, 918b, or 918d related to the reference signals transmitted by the relay UE 1004. The first device, in some devices, may repeat the second phase of the beam training procedure until a feedback indicating a successful transmission is received from the at least one UE. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

Finally, at 1406, the first device may transmit, to the at least one UE via the at least one second wireless device or the at least one network node, or receive, from the at least one UE via the at least one second wireless device or the at least one network node, data based on the performed beam training procedure. For example, 1406 may be performed by data transmission component 2044 or 2244. In some aspects, the first device may transmit an ID associated with a particular ON/OFF state of the at least one second wireless device and the at least one network node for a data transmission mode. In some aspects, transmitting data to the at least one UE or receiving data from the at least one UE based on the performed beam training may include transmitting or receiving data via (1) the at least one second wireless device when the at least one second wireless device is indicated to be in an ON state and (2) the at least one network node when the at least one network node is indicated to be in an ON state.

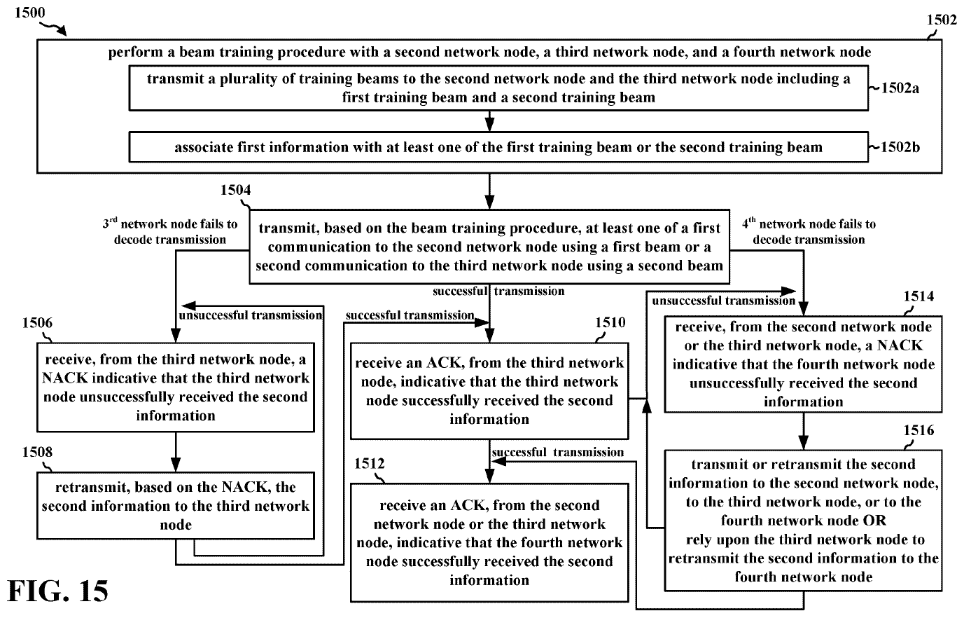

FIG. 15 is a flowchart 1500 of a method of wireless communication. The method may be performed by a first device (e.g., the base station 102/180, 602, 702, 802, and 1002; the apparatus 2202; the apparatus 2002). At 1502, the first device may associate each of a multiple IDs for a beam training procedure with a particular ON/OFF state of at least one second wireless device and at least one network node for the beam training procedure. For example, 1502 may be performed by mode identifier component 2040 or 2240. In some aspects, there may be multiple relay devices and multiple network nodes and to indicate a state for each would take a same number of bits as the number of devices involved in the beam training procedure (and data transmission). Associating a set of IDs with particular ON/OFF states may decrease the overhead by associating ON/OFF states that will be used for beam training or data transmission with a (mode) ID instead of associating all possible ON/OFF states. For example, a set of multiple second wireless devices (e.g., relays devices) may be used in a configuration in which they are all in an ON state or all in an OFF state and two IDs (equivalent to one bit) may be used to indicate the state for the set of multiple second wireless devices. For example, referring to FIG. 6A, base station 602 may associate 610 different ON/OFF states with different IDs.

At 1504, the first device (e.g., a base station or UE) may transmit, to at least one second wireless device (e.g., a relay UE) and at least one network node (e.g., a RIS and RIS controller), at least one indication of an ON/OFF state of the at least one second wireless device and the at least one network node for a beam training procedure. The beam training procedure may be associated with at least one UE (a receiving UE), the at least one second wireless device, and the at least one network node. In some aspects, the at least one indication of the ON/OFF state further indicates an ON/OFF state of the first device. Each ON/OFF state of the at least one second wireless device and the at least one network node for the beam training procedure (and/or the first device), in some aspects, is associated with one of a set of mode IDs for the beam training procedure. For example, referring to FIGS. 6A, 7A, 8A, and 9, the base station 602, 702, 802, and/or 902 may transmit a mode ID 612, ID in reference signal 710, ID 812, and/or ID 912 to one or more of a relay device 604, 704, 804, 904 and a RIS controller 607, 707, 807, and/or 907. For example, 1504 may be performed by a mode identifier component 2040 or 2240.

At 1506, the first device may perform, based on the at least one indication of the ON/OFF state, the beam training procedure with the at least one second wireless device, the at least one network node, and the at least one UE. For example, 1506 (including 1506a-1506f) may be performed by beam training component 2042 or 2242. Performing the beam training, in some aspects, includes performing two phases of beam training. For example, the beam training procedure may include a first phase in which the first device transmits, at 1506a, a first set of transmissions to the at least one second device based on a transmitted first indication that the at least one second device is ON and that the at least one network node is OFF. For example, referring to FIGS. 7A and 7B, the base station 702 may transmit, and relay device 704 may receive, a reference signal 710 that includes a mode ID (ID2) indicating that the relay device 704 is in an ON state and that a RIS 706 is in an OFF state. The first phase of the beam training procedure may further include receiving, at 1506b, a feedback from the at least one second device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, (4) an indication that the at least one second device received at least one transmission in the first set of transmissions with a measured characteristic that is below a threshold value, or (5) information relating to at least one transmission in the first set of transmissions. For example, referring to FIGS. 7A and 7B, the base station 702 may receive feedback 718 from relay device 704.

In some aspects, the first phase of the beam training procedure also includes the first device transmitting, at 1506c, a second set of transmissions to the at least one UE via the at least one network node based on a transmitted second indication that the at least one second device is OFF and that the at least one network node is ON. The first device may also transmit at least a subset of the second set of transmissions to the at least one UE not via the at least one network node (e.g., directly). For example, referring to FIGS. 8A and 8B, the base station 802 may transmit a mode ID 812 to relay device 804 and to RIS controller 707 indicating that the relay device 804 is in an OFF state and that the RIS is in an ON state. The base station 802 may also transmit a set of reference signals 816a and/or 816c to the UE 808 via the RIS 806 and directly. The first device may receive, at 1506d, a feedback from the at least one UE, where the feedback includes at least one of (1) an ACK associated with at least one transmission in the second set of transmissions and (2) a NACK associated with at least one transmission in the second set of transmissions. For example, referring to FIGS. 8A and 8B, the base station 802 may receive feedback 818a and/or 818c including one of an ACK or a NACK from UE 808 (either directly or via RIS 806).

The first phase of the beam training procedure, in some aspects, may include a first number of repetitions of the first set of transmissions and the second set of transmissions. In some aspects, the first set of transmissions and the second set of transmissions may be configured to repeat a different number of times. The first phase of the beam training procedure, in some aspects, may include repeating the first phase of the beam training procedure until a particular feedback is received from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission. In some aspects, a network node (e.g., a RIS, or RIS controller) may not be able to identify that the particular feedback has been transmitted and/or received and the first device may transmit, at 1506e, an indication to the at least one network node relating to the ACK to instruct the at least one network node to proceed to the second phase of the beam training procedure. The indication to instruct the at least one network node to proceed to the second phase of the beam training procedure may be transmitted wirelessly or through a wired connection depending on the capabilities of the network node.

The second phase of the beam training procedure, in some aspects, may include a third set of transmissions that may be transmitted by the at least one second device to the at least one UE. For example, referring to FIGS. 9 and 10A-10D, the relay UE 1004 may transmit reference signals 916e and/or 916g to the UE 1008 (directly or via RIS 1006). The first device may receive, at 1506f, feedback related to the third set of transmissions transmitted in the second phase of the beam training procedure. The third set of transmissions may be associated with one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the base station 1002 may receive one or more of feedback 918a, 918b, or 918d related to the reference signals transmitted by the relay UE 1004. The first device, in some devices, may repeat the second phase of the beam training procedure until a feedback indicating a successful transmission is received from the at least one UE. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

At 1508, the first device may transmit an ID associated with a particular ON/OFF state of the at least one second wireless device and the at least one network node for a data transmission mode. For example, referring to FIGS. 11A-12B, a base station may transmit mode ID 1114, 1134, 1215, and/or 1235. For example, 1508 may be performed by data transmission component 2044 or 2244.

Finally, at 1510, the first device may transmit, to the at least one UE via the at least one second wireless device or the at least one network node, or receive, from the at least one UE via the at least one second wireless device or the at least one network node, data based on the performed beam training procedure. For example, 1506 may be performed by data transmission component 2044 or 2244. In some aspects, transmitting data to the at least one UE or receiving data from the at least one UE based on the performed beam training may include transmitting or receiving data via (1) the at least one second wireless device when the at least one second wireless device is indicated to be in an ON state and (2) the at least one network node when the at least one network node is indicated to be in an ON state.

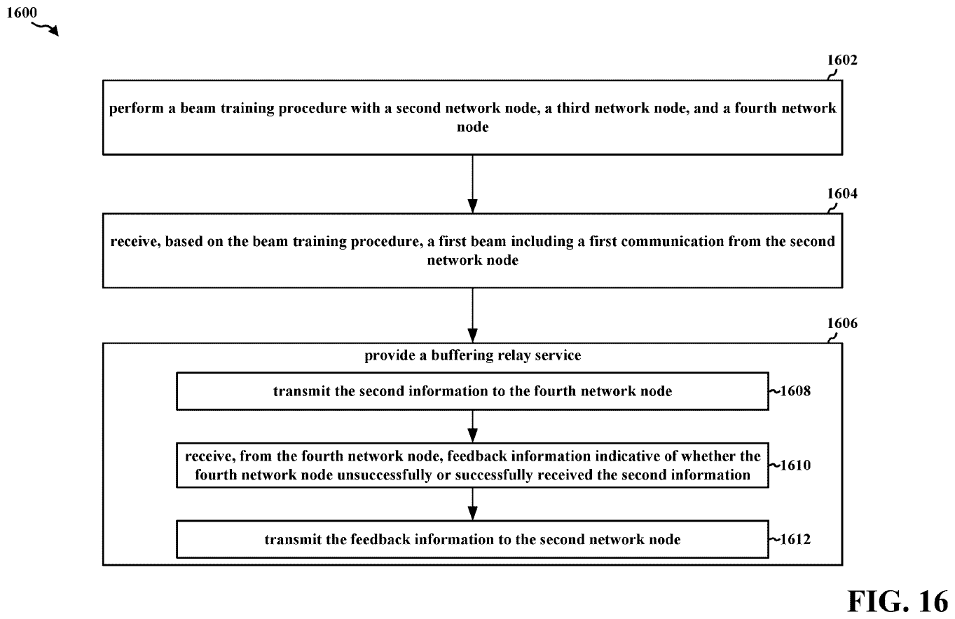

FIG. 16 is a flowchart 1600 of a method of wireless communication. The method may be performed by a second wireless device (e.g., the relay device, 604, 704, 804, and 1004; the apparatus 2002). At 1602, the second wireless device (e.g., a relay UE) may receive, from a first device (e.g., a base station or UE), at least one indication of an ON/OFF state of the second wireless device and at least one network node (e.g., a node including a RIS and a RIS controller) for a beam training procedure. The beam training procedure may be associated with at least one UE, the second wireless device, and the at least one network node transmit. In some aspects, each of the at least one indication(s) of the ON/OFF state is an ID (e.g., a mode ID) for the beam training procedure, and each ID of multiple IDs for the beam training procedure may be associated with a particular ON/OFF state of the second wireless device, the first device, and the at least one network node for the beam training procedure. For example, referring to FIGS. 6A, 7A, 8A, and 9, the relay device 604, 704, 804, 904 may receive from base station 602, 702, 802, and/or 902 a mode ID 612, ID in reference signal 710, ID 812, and/or ID 912. For example, 1602 may be performed by a mode identifier component 2040.

At 1604, the second wireless device may perform, based on the at least one indication of the ON/OFF state, the beam training procedure with the first device, the at least one network node, and the at least one UE. For example, 1604 may be performed by beam training component 2042. Performing the beam training, in some aspects, includes performing two phases of beam training. For example, the beam training procedure may include a first phase in which the second wireless device may receive a first set of transmissions from the first device, based on a transmitted first indication that the second device is ON and that the at least one network node is OFF. For example, referring to FIGS. 7A and 7B, the relay device 704 may receive, from the base station 702, a reference signal 710 that includes a mode ID (ID2) indicating that the relay device 704 is in an ON state and that a RIS 706 is in an OFF state. The first phase of the beam training procedure may further include the second wireless device transmitting a feedback to the first device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, (4) an indication that the at least one second device received at least one transmission in the first set of transmissions with a measured characteristic that is below a threshold value, or (5) information relating to at least one transmission in the first set of transmissions. For example, referring to FIGS. 7A and 7B, the relay device 704 may transmit feedback 718 to the base station 702.

The first phase of the beam training procedure, in some aspects, may include a first number of repetitions of the first set of transmissions. The first phase of the beam training procedure, in some aspects, may include repeating the first phase of the beam training procedure until a particular feedback is received at the first device from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission.

Performing the second phase of the beam training procedure, in some aspects, may include the second wireless transmitting a third set of transmissions to the at least one UE. The third set of transmissions may be associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the relay UE 1004 may transmit reference signals 916e and/or 916g to the UE 1008 (directly or via RIS 1006). The second wireless device may also receive feedback related to the second phase of the beam training procedure. For example, referring to FIGS. 9 and 10A-10D, the relay UE 1004 may receive one or more of feedback 918e and/or 918g related to the reference signals 916e and/or 916g transmitted by the relay UE 1004. The first device, in some devices, may instruct the second wireless device to repeat the second phase of the beam training procedure until a feedback indicating a successful transmission is received from the at least one UE at the first device. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

Finally, at 1606, the second wireless device may transmit at least one of (1) data received from the first device to the at least one UE or (2) data received from the at least one UE to the first device, based on the performed beam training procedure. For example, 1606 may be performed by data transmission component 2044. In some aspects, the second wireless device may receive an ID associated with a particular ON/OFF state of the second wireless device and the at least one network node for a data transmission mode. In some aspects, transmitting at least one of (1) data received from the first device to the at least one UE or (2) data received from the at least one UE to the first device, based on the performed beam training procedure may include transmitting or receiving data via the at least one network node when the at least one network node is indicated to be in an ON state.

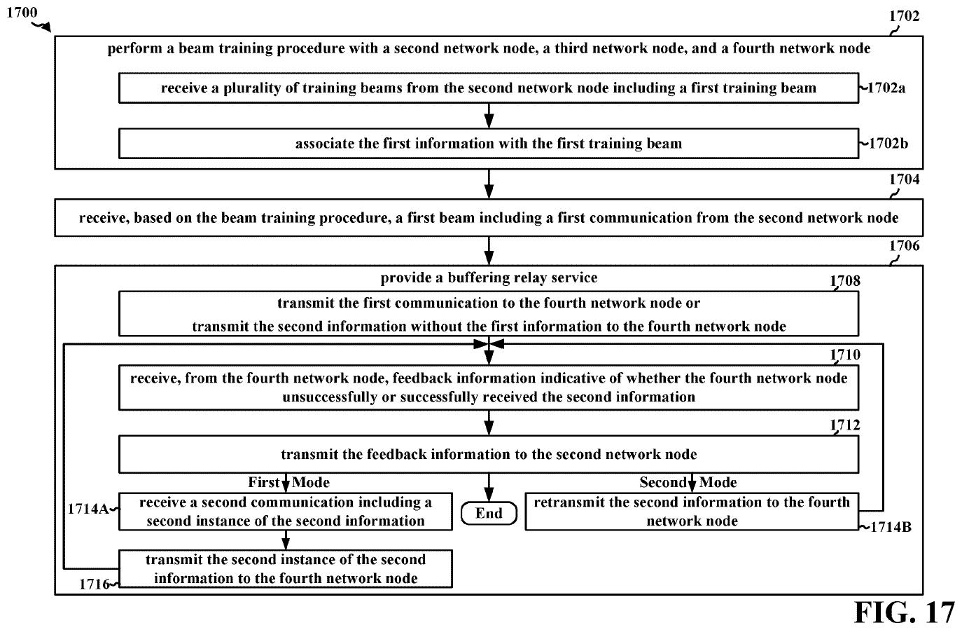

FIG. 17 is a flowchart 1700 of a method of wireless communication. The method may be performed by a second wireless device (e.g., the relay device, 604, 704, 804, and 1004; the apparatus 2002). At 1702, the second wireless device (e.g., a relay UE) may receive, from a first device (e.g., a base station or UE), at least one indication of an ON/OFF state of the second wireless device and at least one network node (e.g., a node including a RIS and a RIS controller) for a beam training procedure. The beam training procedure may be associated with at least one UE, the second wireless device, and the at least one network node transmit. In some aspects, each of the at least one indication(s) of the ON/OFF state is an ID (e.g., a mode ID) for the beam training procedure, and each ID of multiple IDs for the beam training procedure may be associated with a particular ON/OFF state of the second wireless device, the first device, and the at least one network node for the beam training procedure. For example, referring to FIGS. 6A, 7A, 8A, and 9, the relay device 604, 704, 804, 904 may receive from base station 602, 702, 802, and/or 902 a mode ID 612, ID in reference signal 710, ID 812, and/or ID 912. For example, 1702 may be performed by a mode identifier component 2040.

At 1704, the second wireless device may perform, based on the at least one indication of the ON/OFF state, the beam training procedure with the first device, the at least one network node, and the at least one UE. For example, 1704 (including 1704a-1704d) may be performed by beam training component 2042. Performing the beam training, in some aspects, includes performing two phases of beam training. For example, the beam training procedure may include a first phase in which the second wireless device may receive, at 1704a, a first set of transmissions from the first device, based on a transmitted first indication that the second device is ON and that the at least one network node is OFF. For example, referring to FIGS. 7A and 7B, the relay device 704 may receive, from the base station 702, a reference signal 710 that includes a mode ID (ID2) indicating that the relay device 704 is in an ON state and that a RIS 706 is in an OFF state. The first phase of the beam training procedure may further include the second wireless device transmitting, at 1704b, a feedback to the first device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, (4) an indication that the at least one second device received at least one transmission in the first set of transmissions with a measured characteristic that is below a threshold value, or (5) information relating to at least one transmission in the first set of transmissions. For example, referring to FIGS. 7A and 7B, the relay device 704 may transmit feedback 718 to the base station 702.

The first phase of the beam training procedure, in some aspects, may include a first number of repetitions of the first set of transmissions. The first phase of the beam training procedure, in some aspects, may include repeating the first phase of the beam training procedure until a particular feedback is received at the first device from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission.

Performing the second phase of the beam training procedure, in some aspects, may include the second wireless device transmitting, at 1704c, a third set of transmissions to the at least one UE. The third set of transmissions may be associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the relay UE 1004 may transmit reference signals 917e and/or 917g to the UE 1008 (directly or via RIS 1006). The second wireless device may also receive, at 1704d, feedback related to the second phase of the beam training procedure. For example, referring to FIGS. 9 and 10A-10D, the relay UE 1004 may receive one or more of feedback 918e and/or 918g related to the reference signals 917e and/or 917g transmitted by the relay UE 1004. The first device, in some devices, may instruct the second wireless device to repeat the second phase of the beam training procedure until a feedback indicating a successful transmission is received from the at least one UE at the first device. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

At 1706, the second wireless device may receive an ID associated with a particular ON/OFF state of the second wireless device and the at least one network node for a data transmission mode. For example, referring to FIGS. 11A-12B, a second wireless device (or relay device) may receive mode ID 1114, 1134, 1215, and/or 1235. For example, 1706 may be performed by data transmission component 2044.

Finally, at 1708, the second wireless device may transmit at least one of (1) data received from the first device to the at least one UE or (2) data received from the at least one UE to the first device, based on the performed beam training procedure. For example, 1708 may be performed by data transmission component 2044. In some aspects, transmitting at least one of (1) data received from the first device to the at least one UE or (2) data received from the at least one UE to the first device, based on the performed beam training procedure may include transmitting or receiving data via the at least one network node when the at least one network node is indicated to be in an ON state.

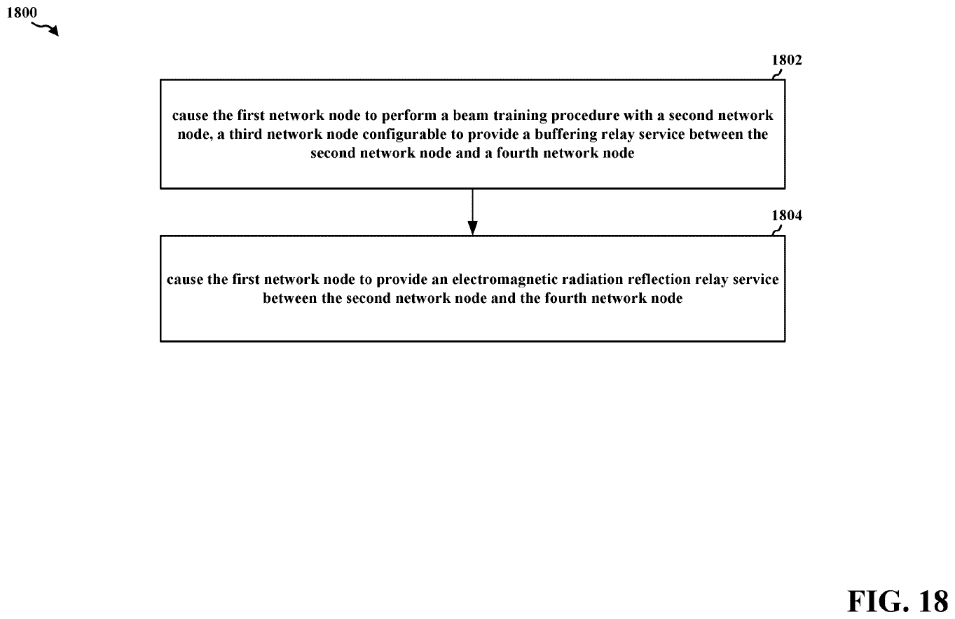

FIG. 18 is a flowchart 1800 of a method of wireless communication. The method may be performed by a network node (e.g., a network node including the RIS, 606, 706, 806, and 1006 and the RIS controller 607, 707, 807, and 1007; the apparatus 2102). At 1802, the network node may receive, from a first device (e.g., a base station or UE), at least one indication of an ON/OFF state of at least one second wireless device (e.g., a relay UE) and the network node for a beam training procedure. The beam training procedure may be associated with at least one UE, the at least one second wireless device, and the network node transmit. In some aspects, each of the at least one indication(s) of the ON/OFF state is an ID (e.g., a mode ID) for the beam training procedure, and each ID of multiple IDs for the beam training procedure may be associated with a particular ON/OFF state of the second wireless device, the first device, and the at least one network node for the beam training procedure. For example, referring to FIGS. 6A, 7A, 8A, and 9, the RIS controller 607, 707, 807, 907 may receive from base station 602, 702, 802, and/or 902 a mode ID 612, ID in reference signal 710, ID 812, and/or ID 912. For example, 1802 may be performed by a mode identifier component 2140.

At 1804, the network node may perform, based on the at least one indication of the ON/OFF state, the beam training procedure with the first device, the at least one second wireless device, and the at least one UE. For example, 1804 may be performed by beam training component 2142. Performing the beam training, in some aspects, includes performing two phases of beam training. For example, the beam training procedure may include a first phase in which the network node may reflect a second set of transmissions to the at least one UE from the first device based on a transmitted second indication that the at least one second device is OFF and that the at least one network node is ON. For example, referring to FIGS. 8A and 8B, the RIS 806 (or RIS controller 807) may receive a mode ID 812 indicating for the RIS to be in an ON state (and that a relay device 804 is in an OFF state), the RIS 806 may then reflect, from the base station 802, a reference signal 816a as reflected reference signal 816b. The first phase of the beam training procedure may further include the network node reflecting reflect a feedback from the at least one UE to the first device, where the feedback includes at least one of (1) an acknowledgment (ACK) associated with at least one transmission in the second set of transmissions and (2) a negative acknowledgement (NACK) associated with at least one transmission in the second set of transmissions. For example, referring to FIGS. 8A and 8B, the network node (e.g., RIS 806) may reflect feedback 818b to the base station 802.

The first phase of the beam training procedure, in some aspects, may include a first number of repetitions of the first set of transmissions. The first phase of the beam training procedure, in some aspects, may include repeating the first phase of the beam training procedure until a particular feedback is received at the first device from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission.

In some aspects, the network node may receive an indication to switch from the first phase to the second phase from the first device or from the at least one UE. The received indication to switch, in some aspects, may be based on the reflected feedback associated with the at least one transmission in the second set of transmissions. For example, in some aspects, a network node (e.g., a RIS, or RIS controller) may not be able to identify that the particular feedback has been transmitted and/or received and the first device may transmit an indication to the at least one network node relating to an ACK associated with the first phase to instruct the at least one network node to proceed to the second phase of the beam training procedure. The indication to instruct the at least one network node to proceed to the second phase of the beam training procedure may be transmitted wirelessly or through a wired connection depending on the capabilities of the network node. For example, referring to FIG. 12A, a network node (e.g., a RIS or RIS controller) may receive DCI 1207 or some other control information indicating for the network node to proceed to a second phase of the beam training procedure.

Performing the second phase of the beam training procedure, in some aspects, may include the network node reflecting a third set of transmissions from the at least one second wireless device to the at least one UE. The third set of transmissions may be associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the RIS 1006 may reflect reference signals 916e to the UE 1008. The network node may also reflect feedback related to the second phase of the beam training procedure from the at least one UE to the at least one second wireless device. For example, referring to FIGS. 9 and 10A-10D, the RIS 1006 may reflect feedback 918f related to the reference signals 916e transmitted by the relay UE 1004. The first device, in some devices, may instruct the network node to repeat the second phase of the beam training procedure until a feedback indicating a successful transmission is received from the at least one UE at the first device. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

Finally, at 1806, the network node device may configure a set of configurable elements of the network node to reflect at least one of (1) data transmitted from the first device to the at least one UE or (2) data transmitted from the at least one UE to the first device, based on the performed beam training procedure. For example, 1806 may be performed by data transmission component 2144. The network node may receive an ID associated with a particular ON/OFF state of the at least one second wireless device and the one network node for a data transmission mode and configuring the set of configurable elements may be based on the received ID. For example, referring to FIGS. 11A-12B, a network node may receive mode ID 1114, 1134, 1215, and/or 1235.

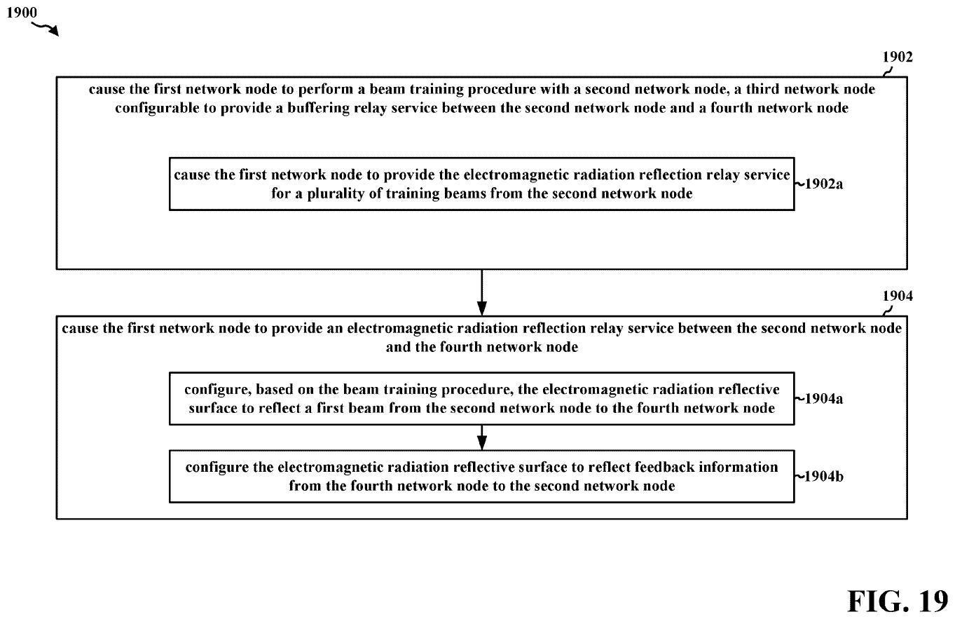

FIG. 19 is a flowchart 1900 of a method of wireless communication. The method may be performed by a network node (e.g., a network node including the RIS, 606, 706, 806, and 1006 and the RIS controller 607, 707, 807, and 1007; the apparatus 2102). At 1902, the network node may receive, from a first device (e.g., a base station or UE), at least one indication of an ON/OFF state of at least one second wireless device (e.g., a relay UE) and the network node for a beam training procedure. The beam training procedure may be associated with at least one UE, the at least one second wireless device, and the network node transmit. In some aspects, each of the at least one indication(s) of the ON/OFF state is an ID (e.g., a mode ID) for the beam training procedure, and each ID of multiple IDs for the beam training procedure may be associated with a particular ON/OFF state of the second wireless device, the first device, and the at least one network node for the beam training procedure. For example, referring to FIGS. 6A, 7A, 8A, and 9, the RIS controller 607, 707, 807, 907 may receive from base station 602, 702, 802, and/or 902 a mode ID 612, ID in reference signal 710, ID 812, and/or ID 912. For example, 1902 may be performed by a mode identifier component 2140.

At 1904, the network node may perform, based on the at least one indication of the ON/OFF state, the beam training procedure with the first device, the at least one second wireless device, and the at least one UE. For example, 1904 (including 1904a-1904e) may be performed by beam training component 2142. Performing the beam training, in some aspects, includes performing two phases of beam training. For example, the beam training procedure may include a first phase in which the network node may reflect, at 1904a, a second set of transmissions to the at least one UE from the first device based on a transmitted second indication that the at least one second device is OFF and that the at least one network node is ON. For example, referring to FIGS. 8A and 8B, the RIS 806 (or RIS controller 807) may receive a mode ID 812 indicating for the RIS to be in an ON state (and that a relay device 804 is in an OFF state), the RIS 806 may then reflect, from the base station 802, a reference signal 816a as reflected reference signal 816b. The first phase of the beam training procedure may further include the network node reflecting, at 1904b, reflect a feedback from the at least one UE to the first device, where the feedback includes at least one of (1) an acknowledgment (ACK) associated with at least one transmission in the second set of transmissions and (2) a negative acknowledgement (NACK) associated with at least one transmission in the second set of transmissions. For example, referring to FIGS. 8A and 8B, the network node (e.g., RIS 806) may reflect feedback 818b to the base station 802.

The first phase of the beam training procedure, in some aspects, may include a first number of repetitions of the first set of transmissions. The first phase of the beam training procedure, in some aspects, may include repeating the first phase of the beam training procedure until a particular feedback is received at the first device from the at least one UE or from the at least one second device. The particular feedback for ending the first phase of the beam training procedure may include one of (1) the received feedback from the at least one second device or the received feedback from the at least one UE indicating a successful (e.g., accurate) transmission or (2) the received feedback from the at least one second device and the received feedback from the at least one UE indicates a successful (e.g., accurate) transmission.

In some aspects, the network node may receive, at 1904c, an indication to switch from the first phase to the second phase from the first device or from the at least one UE. The received indication to switch, in some aspects, may be based on the reflected feedback associated with the at least one transmission in the second set of transmissions. For example, in some aspects, a network node (e.g., a RIS, or RIS controller) may not be able to identify that the particular feedback has been transmitted and/or received and the first device may transmit an indication to the at least one network node relating to an ACK associated with the first phase to instruct the at least one network node to proceed to the second phase of the beam training procedure. The indication to instruct the at least one network node to proceed to the second phase of the beam training procedure may be transmitted wirelessly or through a wired connection depending on the capabilities of the network node. For example, referring to FIG. 12A, a network node (e.g., a RIS or RIS controller) may receive DCI 1207 or some other control information indicating for the network node to proceed to a second phase of the beam training procedure.

Performing the second phase of the beam training procedure, in some aspects, may include the network node reflecting, at 1904d, a third set of transmissions from the at least one second wireless device to the at least one UE. The third set of transmissions may be associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. For example, referring to FIGS. 9 and 10A-10D, the RIS 1006 may reflect reference signals 916e to the UE 1008. The network node may also reflect, at 1904e, feedback related to the second phase of the beam training procedure from the at least one UE to the at least one second wireless device. For example, referring to FIGS. 9 and 10A-10D, the RIS 1006 may reflect feedback 918f related to the reference signals 916e transmitted by the relay UE 1004. The first device, in some devices, may instruct the network node to repeat the second phase of the beam training procedure until a feedback indicating a successful transmission is received from the at least one UE at the first device. In some aspects, the second phase of the beam training procedure may include a second number of repetitions of the third set of transmissions. The feedback related to the first phase and the feedback related to the second phase of the beam training procedure, in some aspects may be received after the first number of repetitions of the first set of transmissions and the second set of transmissions and the second number of repetitions of the third set of transmissions. In other aspects, feedback may be received after each repetition and determinations to proceed to a data transmission or repeat a phase of the beam training procedure may be made after the first number of repetitions of the first set of transmissions and the second set of transmissions and the second number of repetitions of the third set of transmissions.

At 1906, the network node may receive an ID associated with a particular ON/OFF state of the at least one second wireless device and the network node for a data transmission mode. For example, referring to FIGS. 11A-12B, a network node may receive mode ID 1114, 1134, 1215, and/or 1235. For example, 1906 may be performed by data transmission component 2144. Finally, at 1908, the network node device may configure a set of configurable elements of the network node to reflect at least one of (1) data transmitted from the first device to the at least one UE or (2) data transmitted from the at least one UE to the first device, based on the performed beam training procedure. For example, 1908 may be performed by data transmission component 2144. For example, referring to FIGS. 11A-12B, the network node may reflect one of data 1116, 1136, 1216, or 1236 based on mode ID 1114, 1134, 1215, or 1235, respectively.

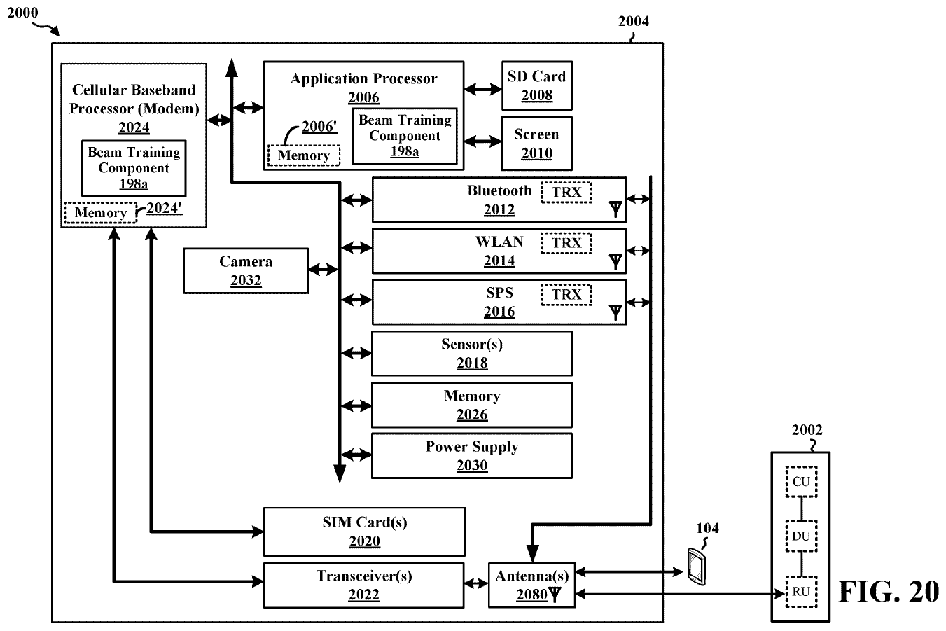

FIG. 20 is a diagram 2000 illustrating an example of a hardware implementation for an apparatus 2002. The apparatus 2002 may be a UE, a component of a UE, or may implement UE functionality. In some aspects, the apparatus 2002 may include a cellular baseband processor 2004 (also referred to as a modem) coupled to a cellular RF transceiver 2022. In some aspects, the apparatus 2002 may further include one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, or a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359. In one configuration, the apparatus 2002 may be a modem chip and include just the baseband processor 2004, and in another configuration, the apparatus 2002 may be the entire UE (e.g., see 350 of FIG. 3) and include the additional modules of the apparatus 2002.

The communication manager 2032 includes a mode identifier component 2040 that is configured to associate each of multiple IDs for a beam training procedure with a particular ON/OFF state of at least one second wireless device and at least one network node for the beam training procedure and transmit and/or receive at least one indication of an ON/OFF state of at least one second wireless device and at least one network node for a beam training procedure, e.g., as described in connection with 1402, 1502, 1504, 1602, 1702, and 1704 of FIGS. 14-17. The communication manager 2032 further includes a beam training component 2042 that receives input in the form of a mode ID from the component 2040 and is configured to perform, based on the at least one indication of the ON/OFF state, the beam training procedure with the first device (or the at least one second wireless device), the at least one network node, and the at least one UE, e.g., as described in connection with 1404, 1506, 1604, and 1704 of FIGS. 14-17. The communication manager 2032 further includes a data transmission component 2044 that receives input in the form of a mode ID from the component 2040 and is configured to transmit, to the at least one UE via the at least one second wireless device or the at least one network node, or receive, from the at least one UE via the at least one second wireless device or the at least one network node, data based on the performed beam training procedure and/or to transmit at least one of (1) data received from the first device to the at least one UE or (2) data received from the at least one UE to the first device, based on the performed beam training procedure, e.g., as described in connection with 1406, 1508, 1510, 1606, 1706, and 1708 of FIGS. 14-17.

The apparatus may include additional components that perform each of the blocks of the algorithm in the flowcharts of FIGS. 14-17. As such, each block in the flowcharts of FIGS. 14-17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the cellular baseband processor 2004, includes means for transmitting, to at least one second wireless device and at least one network node, at least one indication of an ON/OFF state of the at least one second wireless device and the at least one network node for a beam training procedure, the beam training procedure being associated with at least one UE, the at least one second wireless device, and the at least one network node. The apparatus 2002, and in particular the cellular baseband processor 2004, may also include means for performing, based on the at least one indication of the ON/OFF state, the beam training procedure with the at least one second wireless device, the at least one network node, and the at least one UE. The apparatus 2002, and in particular the cellular baseband processor 2004, may also include means for transmitting, to the at least one UE via the at least one second wireless device or the at least one network node, or receiving, from the at least one UE via the at least one second wireless device or the at least one network node, data based on the performed beam training procedure. The apparatus 2002, and in particular the cellular baseband processor 2004, may also include means for associating each of multiple IDs for the beam training procedure with a particular ON/OFF state of the at least one second wireless device and the at least one network node for the beam training procedure. The apparatus 2002, and in particular the cellular baseband processor 2004, may also include means for transmitting an ID associated with a particular ON/OFF state of the at least one second wireless device and the at least one network node of a data transmission mode, where transmitting data to the at least one UE or receiving data from the at least one UE based on the performed beam training includes transmitting or receiving data via (1) the at least one second wireless device when the at least one second wireless device is indicated to be in an ON state and (2) the at least one network node when the at least one network node is indicated to be in an ON state. The apparatus 2002, and in particular the cellular baseband processor 2004, may also include means for transmitting, in a first phase of the beam training procedure, a first set of transmissions to the at least one second device based on a transmitted first indication that the at least one second device is ON and that the at least one network node is OFF. The apparatus 2002, and in particular the cellular baseband processor 2004, may also include means for receiving a feedback from the at least one second device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, or (4) an indication that the at least one second device received at least one transmission in the first set of transmissions with a measured characteristic that is below a threshold value. The apparatus 2002, and in particular the cellular baseband processor 2004, may also include means for transmitting, in the first phase of the beam training procedure, a second set of transmissions to the at least one UE via the at least one network node based on a transmitted second indication that the at least one second device is OFF and that the at least one network node is ON. The apparatus 2002, and in particular the cellular baseband processor 2004, may also include means for receiving a feedback from the at least one UE, where the feedback includes at least one of (1) an ACK associated with at least one transmission in the second set of transmissions and (2) a NACK associated with at least one transmission in the second set of transmissions. The apparatus 2002, and in particular the cellular baseband processor 2004, may also include means for receiving feedback related to the second phase of the beam training procedure, where the third set of transmissions are associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. The apparatus 2002, and in particular the cellular baseband processor 2004, may also include means for repeating the first phase of the beam training procedure until a particular feedback is received from the at least one UE or from the at least one second device, where the particular feedback includes one of (1) the received feedback from the at least one second device or the received feedback from the at least one UE indicates a successful transmission or (2) the received feedback from the at least one second device and the received feedback from the at least one UE indicates a successful transmission. The apparatus 2002, and in particular the cellular baseband processor 2004, may also include means for repeating the second phase of the beam training procedure until a feedback indicating a successful transmission is received from the at least one UE. The apparatus 2002, and in particular the cellular baseband processor 2004, may also include means for transmitting an indication to the at least one network node relating to the ACK to instruct the at least one network node to proceed to the second phase of the beam training procedure.

The apparatus 2002, and in particular the cellular baseband processor 2004, may also include means for receiving, from a first device, at least one indication of an ON/OFF state of the second wireless device and at least one network node for a beam training procedure, the beam training procedure being associated with at least one UE, the second wireless device, and the at least one network node. The apparatus 2002, and in particular the cellular baseband processor 2004, may also include means for performing, based on the at least one indication of the ON/OFF state, the beam training procedure with the first device, the at least one network node, and the at least one UE. The apparatus 2002, and in particular the cellular baseband processor 2004, may also include means for transmitting at least one of (1) data received from the first device to the at least one UE or (2) data received from the at least one UE to the first device, based on the performed beam training procedure. The apparatus 2002, and in particular the cellular baseband processor 2004, may also include means for receiving, in a first phase of the beam training procedure, a first set of transmissions from the first device, based on a transmitted first indication that the second device is ON and that the at least one network node is OFF. The apparatus 2002, and in particular the cellular baseband processor 2004, may also include means for transmitting a feedback to the first device, where the feedback is one of (1) an ACK associated with at least one transmission in the first set of transmissions, (2) a NACK associated with at least one transmission in the first set of transmissions, (3) an indication that the second wireless device received at least one transmission in the first set of transmissions with a measured characteristic that is above a threshold value, or (4) an indication that the second device received at least one transmission in the first set of transmissions with a measured characteristic that is below a threshold value. The apparatus 2002, and in particular the cellular baseband processor 2004, may also include means for transmitting a third set of transmissions to the at least one UE, where the third set of transmissions are associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. The apparatus 2002, and in particular the cellular baseband processor 2004, may also include means for receive feedback related to the second phase of the beam training procedure. The means may be one or more of the components of the apparatus 2002 configured to perform the functions recited by the means. As described supra, the apparatus 2002 may include the TX Processor 368, the RX Processor 356, and the controller/processor 359. As such, in one configuration, the means may be the TX Processor 368, the RX Processor 356, and the controller/processor 359 configured to perform the functions recited by the means.

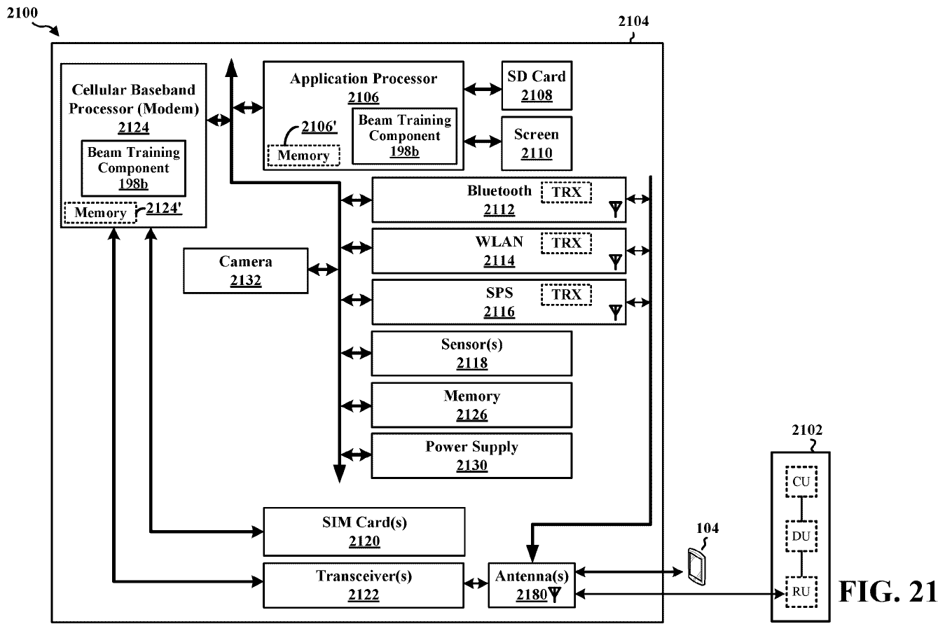

FIG. 21 is a diagram 2100 illustrating an example of a hardware implementation for an apparatus 2102. The apparatus 2102 may be a UE, a component of a UE, or may implement UE functionality. In some aspects, the apparatus 2102 may include a cellular baseband processor 2104 (also referred to as a modem) coupled to a cellular RF transceiver 2122. In some aspects, the apparatus 2102 may further include one or more subscriber identity modules (SIM) cards 2120, an application processor 2106 coupled to a secure digital (SD) card 2108 and a screen 2110, a Bluetooth module 2112, a wireless local area network (WLAN) module 2114, a Global Positioning System (GPS) module 2116, or a power supply 2118. The cellular baseband processor 2104 communicates through the cellular RF transceiver 2122 with the UE 104 and/or BS 102/180. The cellular baseband processor 2104 may include a computer-readable medium/memory. The computer-readable medium/memory may be non-transitory. The cellular baseband processor 2104 is responsible for general processing, including the execution of software stored on the computer-readable medium/memory. The software, when executed by the cellular baseband processor 2104, causes the cellular baseband processor 2104 to perform the various functions described supra. The computer-readable medium/memory may also be used for storing data that is manipulated by the cellular baseband processor 2104 when executing software. The cellular baseband processor 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the cellular baseband processor 2104. The cellular baseband processor 2104 may be a component of the UE 350 and may include the memory 360 and/or at least one of the TX processor 368, the RX processor 356, and the controller/processor 359. In one configuration, the apparatus 2102 may be a modem chip and include just the baseband processor 2104, and in another configuration, the apparatus 2102 may be the entire UE (e.g., see 350 of FIG. 3) and include the additional modules of the apparatus 2102.

The communication manager 2132 includes a mode identifier component 2140 that is configured to receive, from a first device (e.g., a base station or UE), at least one indication of an ON/OFF state of at least one second wireless device (e.g., a relay UE) and the network node for a beam training procedure, e.g., as described in connection with 1802 and 1902 of FIGS. 18 and 19. The communication manager 2132 further includes a beam training component 2142 that receives input in the form of a mode ID from the component 2140 and is configured to perform, based on the at least one indication of the ON/OFF state, the beam training procedure with the first device, the at least one second wireless device, and the at least one UE, e.g., as described in connection with 1804 and 1904 of FIGS. 18 and 19. The communication manager 2132 further includes a data transmission component 2144 that is configured to receive an ID associated with a particular ON/OFF state of the at least one second wireless device and the network node for a data transmission mode and configure a set of configurable elements of the network node to reflect at least one of (1) data transmitted from the first device to the at least one UE or (2) data transmitted from the at least one UE to the first device, based on the performed beam training procedure, e.g., as described in connection with 1806, 1906, 1908 of FIGS. 18 and 19.

The apparatus may include additional components that perform each of the blocks of the algorithm in the flowcharts of FIGS. 18 and 19. As such, each block in the flowcharts of FIGS. 18 and 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2102 may include a variety of components configured for various functions. In one configuration, the apparatus 2102, and in particular the cellular baseband processor 2104, includes means for receiving, from a first device, at least one indication of an ON/OFF state of at least one second wireless device and the network node for a beam training procedure, the beam training procedure being associated with at least one UE, the at least one second wireless device, and the network node. The apparatus 2102, and in particular the cellular baseband processor 2104, may also include means for performing, based on the at least one indication of the ON/OFF state, the beam training procedure with the first device, the at least one second wireless device, and the at least one UE. The apparatus 2102, and in particular the cellular baseband processor 2104, may also include means for configuring a set of configurable elements of the network node to reflect at least one of (1) data transmitted from the first device to the at least one UE or (2) data transmitted from the at least one UE to the first device, based on the performed beam training procedure. The apparatus 2102, and in particular the cellular baseband processor 2104, may also include means for reflecting, in a first phase of the beam training procedure, a second set of transmissions to the at least one UE from the first device based on a transmitted second indication that the at least one second device is OFF and that the at least one network node is ON. The apparatus 2102, and in particular the cellular baseband processor 2104, may also include means for reflecting a feedback from the at least one UE to the first device, where the feedback includes at least one of (1) an ACK associated with at least one transmission in the second set of transmissions and (2) a NACK associated with at least one transmission in the second set of transmissions. The apparatus 2102, and in particular the cellular baseband processor 2104, may also include means for reflecting a third set of transmissions from the at least one second wireless device to the at least one UE, where the third set of transmissions are associated with at least one of an ON/OFF indication indicating (1) that the first device is ON and the network node is ON or (2) that the first device is OFF and the network node is ON. The apparatus 2102, and in particular the cellular baseband processor 2104, may also include means for reflecting feedback related to the second phase of the beam training procedure from the at least one UE to the at least one second wireless device. The apparatus 2102, and in particular the cellular baseband processor 2104, may also include means for switching from the first phase to the second phase after the first number of repetitions of the first set of transmissions and the second set of transmissions. The apparatus 2102, and in particular the cellular baseband processor 2104, may also include means for receiving the feedback associated with the at least one transmission in the second set of transmissions from the at least one UE at a controller of the network node. The apparatus 2102, and in particular the cellular baseband processor 2104, may also include means for switching, based on the feedback, from the first phase to the second phase. The apparatus 2102, and in particular the cellular baseband processor 2104, may also include means for receiving, from the first device, an indication to switch from the first phase to the second phase, where the received indication to switch is based on the reflected feedback associated with the at least one transmission in the second set of transmissions. The means may be one or more of the components of the apparatus 2102 configured to perform the functions recited by the means. As described supra, the apparatus 2102 may include the TX Processor 368, the RX Processor 356, and the controller/processor 359. As such, in one configuration, the means may be the TX Processor 368, the RX Processor 356, and the controller/processor 359 configured to perform the functions recited by the means.

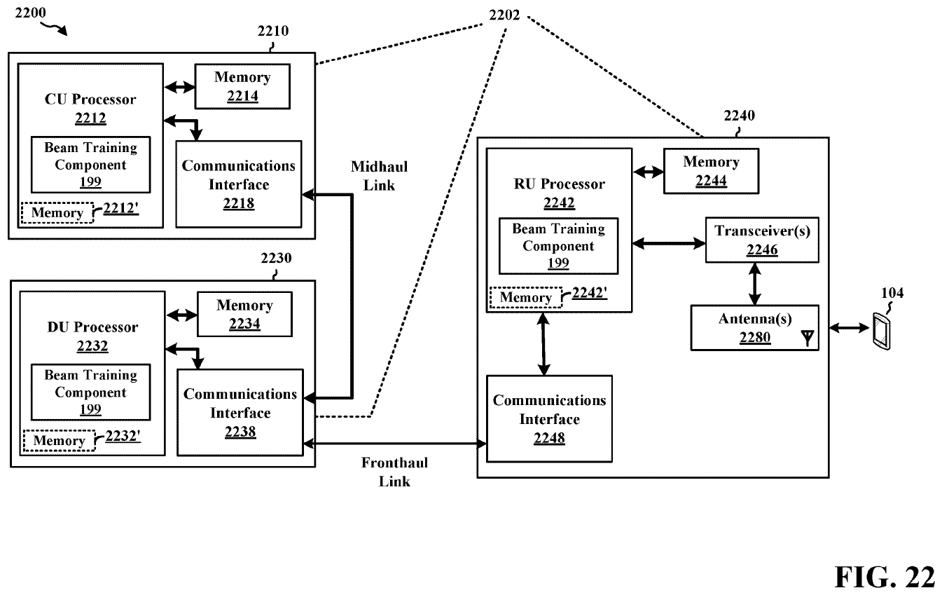

FIG. 22 is a diagram 2200 illustrating an example of a hardware implementation for an apparatus 2202. The apparatus 2202 may be a base station, a component of a base station, or may implement base station functionality. In some aspects, the apparatus 2002 may include a baseband unit 2204. The baseband unit 2204 may communicate through a cellular RF transceiver 2222 with the UE 104. The baseband unit 2204 may include a computer-readable medium/memory. The baseband unit 2204 is responsible for general processing, including the execution of software stored on the computer-readable medium/memory. The software, when executed by the baseband unit 2204, causes the baseband unit 2204 to perform the various functions described supra. The computer-readable medium/memory may also be used for storing data that is manipulated by the baseband unit 2204 when executing software. The baseband unit 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the baseband unit 2204. The baseband unit 2204 may be a component of the base station 310 and may include the memory 376 and/or at least one of the TX processor 316, the RX processor 370, and the controller/processor 375.

The communication manager 2232 includes a mode identifier component 2240 that is configured to associate each of multiple IDs for a beam training procedure with a particular ON/OFF state of at least one second wireless device and at least one network node for the beam training procedure and transmit receive at least one indication of an ON/OFF state of at least one second wireless device and at least one network node for a beam training procedure, e.g., as described in connection with 1402, 1502, and 1504 of FIGS. 14 and 15. The communication manager 2232 further includes a beam training component 2242 that receives input in the form of a mode ID from the component 2240 and is configured to perform, based on the at least one indication of the ON/OFF state, the beam training procedure with the at least one second wireless device, the at least one network node, and the at least one UE, e.g., as described in connection with 1404 and 1506 of FIGS. 14 and 15. The communication manager 2232 further includes a data transmission component 2244 that receives input in the form of a mode ID from the component 2040 and is configured to transmit, to the at least one UE via the at least one second wireless device or the at least one network node, or receive, from the at least one UE via the at least one second wireless device or the at least one network node, data based on the performed beam training procedure, e.g., as described in connection with 1406, 1508, and 1510 of FIGS. 14 and 15.

The apparatus may include additional components that perform each of the blocks of the algorithm in the flowcharts of FIGS. 14 and 15. As such, each block in the flowcharts of FIGS. 14 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the cellular baseband processor 2204, includes means for transmitting, to at least one second wireless device and at least one network node, at least one indication of an ON/OFF state of the at least one second wireless device and the at least one network node for a beam training procedure, the beam training procedure being associated with at least one UE, the at least one second wireless device, and the at least one network node. The apparatus 2202, and in particular the cellular baseband processor 2204, may also include means for performing, based on the at least one indication of the ON/OFF state, the beam training procedure with the at least one second wireless device, the at least one network node, and the at least one UE. The apparatus 2202, and in particular the cellular baseband processor 2204, may also include means for transmitting, to the at least one UE via the at least one second wireless device or the at least one network node, or receiving, from the at least one UE via the at least one second wireless device or the at least one network node, data based on the performed beam training procedure. The apparatus 2202, and in particular the cellular baseband processor 2204, may also include means for associating each of multiple IDs for the beam training procedure with a particular ON/OFF state of the at least one second wireless device and the at least one network node for the beam training procedure. The apparatus 2202, and in particular the cellular baseband processor 2204, may also include means for transmitting an ID associated with a particular ON/OFF state of the at least one second wireless device and the at least one network node of a data transmission mode, where transmitting data to the at least one UE or receiving data from the at least one UE based on the performed beam training includes transmitting or receiving data via (1) the at least one second wireless device when the at least one second wireless device is indicated to be in an ON state and (2) the at least one network node when the at least one network node is indicated to be in an ON state. The apparatus 2202, and in particular the cellular baseband processor 2204, may also include means for transmitting, in a first phase of the beam training procedure, a first set of transmissions to the at least one second device based on a transmitted first indication that the at least one second device is ON and that the at least one network node is OFF. The apparatus 2202, and in particular the cellular baseband processor 2204, may also include means for receiving a feedback from the at least one second device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, or (4) an indication that the at least one second device received at least one transmission in the first set of transmissions with a measured characteristic that is below a threshold value. The apparatus 2202, and in particular the cellular baseband processor 2204, may also include means for transmitting, in the first phase of the beam training procedure, a second set of transmissions to the at least one UE via the at least one network node based on a transmitted second indication that the at least one second device is OFF and that the at least one network node is ON. The apparatus 2202, and in particular the cellular baseband processor 2204, may also include means for receiving a feedback from the at least one UE, where the feedback includes at least one of (1) an ACK associated with at least one transmission in the second set of transmissions and (2) a NACK associated with at least one transmission in the second set of transmissions. The apparatus 2202, and in particular the cellular baseband processor 2204, may also include means for receiving feedback related to the second phase of the beam training procedure, where the third set of transmissions are associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF. The apparatus 2202, and in particular the cellular baseband processor 2204, may also include means for repeating the first phase of the beam training procedure until a particular feedback is received from the at least one UE or from the at least one second device, where the particular feedback includes one of (1) the received feedback from the at least one second device or the received feedback from the at least one UE indicates a successful transmission or (2) the received feedback from the at least one second device and the received feedback from the at least one UE indicates a successful transmission. The apparatus 2202, and in particular the cellular baseband processor 2204, may also include means for repeating the second phase of the beam training procedure until a feedback indicating a successful transmission is received from the at least one UE. The apparatus 2202, and in particular the cellular baseband processor 2204, may also include means for transmitting an indication to the at least one network node relating to the ACK to instruct the at least one network node to proceed to the second phase of the beam training procedure. The means may be one or more of the components of the apparatus 2202 configured to perform the functions recited by the means. As described supra, the apparatus 2202 may include the TX Processor 316, the RX Processor 370, and the controller/processor 375. As such, in one configuration, the means may be the TX Processor 316, the RX Processor 370, and the controller/processor 375 configured to perform the functions recited by the means.

In some aspects of wireless communication, at least one RIS and/or at least one relay (e.g., a relay UE) may be involved in a communication between a first wireless device (e.g., a base station or a UE) and at least one UE. A method for identifying a best configuration for beamforming parameters for communicating between the first device and the at least one UE using at least one of a set of at least one RIS and a set of at least one relay device may include multiple modes of training and/or data transmission for each of the first wireless device, the set of at least one RIS, and the set of at least one relay device. In some aspects, a signaling of a state of each device during training, and for data transmission after training, may be reduced by associating different modes of training and/or data transmission (e.g., different configurations of ON/OFF states of the first device, the set of at least one RIS, and the set of at least one relay device) with different identifiers (IDs). The IDs may then be used to signal each of the devices in set of at least one RIS and/or the set of at least one relay device a state for the device and/or a mode of operation associated with the ID.

For example, in some aspects, there may be multiple relay devices and multiple network nodes and to indicate a state for each would take a same number of bits as the number of devices involved in the beam training procedure (and data transmission). Associating a set of IDs with particular ON/OFF states may decrease the overhead by only associating ON/OFF states that will be used for beam training or data transmission with a (mode) ID instead of associating all possible ON/OFF states. For example, a set of multiple second wireless devices (e.g., relays devices) may be used in a configuration in which they are all in an ON state or all in an OFF state and two IDs (equivalent to one bit) may be used to indicate the state for the set of multiple second wireless devices.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including a memory and at least one processor coupled to the memory and configured to transmit, to at least one second wireless device and at least one network node, at least one indication of an ON/OFF state of the at least one second wireless device and the at least one network node for a beam training procedure, the beam training procedure being associated with at least one UE, the at least one second wireless device, and the at least one network node; perform, based on the at least one indication of the ON/OFF state, the beam training procedure with the at least one second wireless device, the at least one network node, and the at least one UE; and transmit, to the at least one UE via the at least one second wireless device or the at least one network node, or receive, from the at least one UE via the at least one second wireless device or the at least one network node, data based on the performed beam training procedure.

Aspect 2 is the apparatus of aspect 1, where each of the at least one indication of the ON/OFF state is an ID for the beam training procedure.

Aspect 3 is the apparatus of aspect 2, the at least one processor further configured to associate each of multiple IDs for the beam training procedure with a particular ON/OFF state of the at least one second wireless device and the at least one network node for the beam training procedure.

Aspect 4 is the apparatus of any of aspects 2 or 3, the at least one processor further configured to transmit an ID associated with a particular ON/OFF state of the at least one second wireless device and the at least one network node of a data transmission mode, where transmitting data to the at least one UE or receiving data from the at least one UE based on the performed beam training includes transmitting or receiving data via (1) the at least one second wireless device when the at least one second wireless device is indicated to be in an ON state and (2) the at least one network node when the at least one network node is indicated to be in an ON state.

Aspect 5 is the apparatus of any of aspects 1 to 4, where the at least one indication of the ON/OFF state further indicates an ON/OFF state of the first device.

Aspect 6 is the apparatus of any of aspects 1 to 5, where the first device comprises one of a base station or a first UE, the second device comprises a relay UE, and the network node comprises a RIS and a RIS controller.

Aspect 7 is the apparatus of any of aspects 1 to 6, where the at least one processor is configured to perform the beam training procedure by being configured to transmit, in a first phase of the beam training procedure, a first set of transmissions to the at least one second device based on a transmitted first indication that the at least one second device is ON and that the at least one network node is OFF; receive a feedback from the at least one second device, where the feedback is one of (1) an ACK associated with at least one transmission in the first set of transmissions, (2) a NACK associated with at least one transmission in the first set of transmissions, (3) an indication that the at least one second device received at least one transmission in the first set of transmissions with a measured characteristic that is above a threshold value, or (4) an indication that the at least one second device received at least one transmission in the first set of transmissions with a measured characteristic that is below a threshold value; transmit, in the first phase of the beam training procedure, a second set of transmissions to the at least one UE via the at least one network node based on a transmitted second indication that the at least one second device is OFF and that the at least one network node is ON; and receive a feedback from the at least one UE, where the feedback includes at least one of (1) an ACK associated with at least one transmission in the second set of transmissions and (2) a NACK associated with at least one transmission in the second set of transmissions.

Aspect 8 is the apparatus of aspect 7, where at least a subset of the second set of transmissions is transmitted to the at least one UE not via the at least one network node.

Aspect 9 is the apparatus of any of aspects 7 or 8, where the beam training procedure includes the first phase of the beam training procedure and a second phase of the beam training procedure that is performed after the first phase and in which a third set of transmissions are transmitted by the at least one second device to the at least one UE, the at least one processor further configured to receive feedback related to the second phase of the beam training procedure, where the third set of transmissions are associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF.

Aspect 10 is the apparatus of aspect 9, where the first phase of the beam training procedure includes a first number of repetitions of the first set of transmissions and the second set of transmissions and the second phase of the beam training procedure includes a second number of repetitions of the third set of transmissions, where the feedback related to the first phase and the feedback related to the second phase of the beam training procedure is received after the second number of repetitions of the third set of transmissions.

Aspect 11 is the apparatus of aspect 9, the at least one processor further configured to repeat the first phase of the beam training procedure until a particular feedback is received from the at least one UE or from the at least one second device, where the particular feedback includes one of (1) the received feedback from the at least one second device or the received feedback from the at least one UE indicates a successful transmission or (2) the received feedback from the at least one second device and the received feedback from the at least one UE indicates a successful transmission; and repeat the second phase of the beam training procedure until a feedback indicating a successful transmission is received from the at least one UE.

Aspect 12 is the apparatus of aspect 11, where the received feedback from the at least one UE includes an ACK, the at least one processor further configured to transmit an indication to the at least one network node relating to the ACK to instruct the at least one network node to proceed to the second phase of the beam training procedure.

Aspect 13 is the apparatus of any of aspects 1 to 12, further including at least one antenna and a transceiver coupled to the at least one processor.

Aspect 14 is an apparatus for wireless communication including a memory and at least one processor coupled to the memory and configured to receive, from a first device, at least one indication of an ON/OFF state of the second wireless device and at least one network node for a beam training procedure, the beam training procedure being associated with at least one UE, the second wireless device, and the at least one network node; perform, based on the at least one indication of the ON/OFF state, the beam training procedure with the first device, the at least one network node, and the at least one UE; and transmit at least one of (1) data received from the first device to the at least one UE or (2) data received from the at least one UE to the first device, based on the performed beam training procedure.

Aspect 15 is the apparatus of aspect 14, where each of the at least one indication of the ON/OFF state is an ID for the beam training procedure, and each ID of multiple IDs for the beam training procedure is associated with a particular ON/OFF state of the second wireless device, the first device, and the at least one network node for the beam training procedure.

Aspect 16 is the apparatus of any of aspects 14 or 15, where the first device includes one of a base station or a first UE, the second wireless device includes a relay UE, and each network node of the at least one network nodes includes a RIS and a RIS controller.

Aspect 17 is the apparatus of any of aspects 14 to 16, where the at least one processor is configured to perform the beam training procedure by being configured to receive, in a first phase of the beam training procedure, a first set of transmissions from the first device, based on a transmitted first indication that the second device is ON and that the at least one network node is OFF; and transmit a feedback to the first device, where the feedback is one of (1) an ACK associated with at least one transmission in the first set of transmissions, (2) a NACK associated with at least one transmission in the first set of transmissions, (3) an indication that the second wireless device received at least one transmission in the first set of transmissions with a measured characteristic that is above a threshold value, or (4) an indication that the second device received at least one transmission in the first set of transmissions with a measured characteristic that is below a threshold value.

Aspect 18 is the apparatus of aspect 17, where the beam training procedure includes the first phase of the beam training procedure and a second phase of the beam training procedure that is performed after the first phase, the at least one processor further configured to transmit a third set of transmissions to the at least one UE, where the third set of transmissions are associated with at least one of an ON/OFF indication indicating (1) that the first device is ON and the network node is ON, (2) that the first device is ON and the network node is OFF, (3) that the first device is OFF and the network node is ON, or (4) that the first device is OFF and the network node is OFF; and receive feedback related to the second phase of the beam training procedure.

Aspect 19 is the apparatus of any of aspects 14 to 18, further including at least one antenna and a transceiver coupled to the at least one processor.

Aspect 20 is an apparatus for wireless communication including a memory and at least one processor coupled to the memory and configured to receive, from a first device, at least one indication of an ON/OFF state of at least one second wireless device and the network node for a beam training procedure, the beam training procedure being associated with at least one UE, the at least one second wireless device, and the network node; perform, based on the at least one indication of the ON/OFF state, the beam training procedure with the first device, the at least one second wireless device, and the at least one UE; and configure a set of configurable elements of the network node to reflect at least one of (1) data transmitted from the first device to the at least one UE or (2) data transmitted from the at least one UE to the first device, based on the performed beam training procedure.

Aspect 21 is the apparatus of aspect 20, where each of the at least one indication of the ON/OFF state is an ID for the beam training procedure, and each ID of multiple IDs for the beam training procedure is associated with a particular ON/OFF state of the at least one second wireless device, the first device, and the network node for the beam training procedure.

Aspect 22 is the apparatus of any of aspects 20 or 21, where the first device includes one of a base station or a first UE, the at least one second wireless device includes a relay UE, and, and the network node includes a RIS and a RIS controller.

Aspect 23 is the apparatus of any of aspects 20 to 22, where the at least one processor is configured to perform the beam training procedure by being configured to reflect, in a first phase of the beam training procedure, a second set of transmissions to the at least one UE from the first device based on a transmitted second indication that the at least one second device is OFF and that the at least one network node is ON; and reflect a feedback from the at least one UE to the first device, where the feedback includes at least one of (1) an ACK associated with at least one transmission in the second set of transmissions and (2) a NACK associated with at least one transmission in the second set of transmissions.

Aspect 24 is the apparatus of aspect 23, where the beam training procedure includes the first phase of the beam training procedure and a second phase of the beam training procedure that is performed after the first phase, the at least one processor further configured to reflect a third set of transmissions from the at least one second wireless device to the at least one UE, where the third set of transmissions are associated with at least one of an ON/OFF indication indicating (1) that the first device is ON and the network node is ON or (2) that the first device is OFF and the network node is ON; and reflect feedback related to the second phase of the beam training procedure from the at least one UE to the at least one second wireless device.

Aspect 25 is the apparatus of aspect 24, where the first phase of the beam training procedure includes a first number of repetitions of the first set of transmissions and the second set of transmissions, the at least one processor further configured to switch from the first phase to the second phase after the first number of repetitions of the first set of transmissions and the second set of transmissions.

Aspect 26 is the apparatus of aspect 24, the at least one processor further configured to receive the feedback associated with the at least one transmission in the second set of transmissions from the at least one UE at a controller of the network node and switch, based on the feedback, from the first phase to the second phase.

Aspect 27 is the apparatus of aspect 24, the at least one processor further configured to receive, from the first device, an indication to switch from the first phase to the second phase, where the received indication to switch is based on the reflected feedback associated with the at least one transmission in the second set of transmissions.

Aspect 28 is the apparatus of any of aspects 20 to 28, further including at least one antenna and a transceiver coupled to the at least one processor.

Aspect 29 is a method of wireless communication for implementing any of aspects 1 to 28.

Aspect 30 is an apparatus for wireless communication including means for implementing any of aspects 1 to 28.

Aspect 31 is a computer-readable medium storing computer executable code, where the code when executed by a processor causes the processor to implement any of aspects 1 to 28.

What is claimed is:

1. A first network node for wireless communication, comprising:
a memory; and
at least one processor coupled to the memory, wherein the at least one processor is configured to:
perform a beam training procedure with a second network node, a third network node, and a fourth network node, wherein the second network node is configurable to provide an electromagnetic radiation reflection relay service between the first network node and the fourth network node, and wherein the third network node is configurable to provide a buffering relay service between the first network node and the fourth network node; and
transmit, based on the beam training procedure, at least one of:
a first communication to the second network node using a first beam, wherein the first communication includes first information and second information, wherein the first beam is associated with the first information, wherein the second information is destined for the fourth network node, and wherein the first information corresponds to an operational state of the second network node and an operational state of the third network node; or
a second communication to the third network node using a second beam, wherein the second communication includes the first information and the second information, wherein the second beam is associated with the first information.

2. The first network node of claim 1, wherein the second information includes a transport block.

3. The first network node of claim 1, wherein the buffering relay service includes a decode-and-forward relay service or an amplify-and-forward relay service.

4. The first network node of claim 1, wherein the first information is a beam training identifier (ID) indicative of the operational state of the second network node and the operational state of the third network node.

5. The first network node of claim 1, wherein the operational state of the second network node corresponds to whether the second network node is configured to provide the electromagnetic radiation reflection relay service, and wherein the operational state of the third network node corresponds to whether the third network node is configured to provide the buffering relay service.

6. The first network node of claim 1, wherein, to perform the beam training procedure, the at least one processor is configured to:
transmit a plurality of training beams to the second network node and the third network node, wherein the plurality of training beams includes a first training beam and a second training beam; and
associate the first information with at least one of the first training beam or the second training beam, wherein the first beam is associated with the first training beam and the second beam is associated with the second training beam.

7. The first network node of claim 1, wherein the at least one processor is configured to:
receive, from the third network node, a negative acknowledgement (NACK) indicative that the third network node unsuccessfully received the second information; and
retransmit, based on the NACK, the second information to the third network node.

8. The first network node of claim 1, wherein the at least one processor is configured to receive at least one of:
an ACK, from the third network node, indicative that the third network node successfully received the second information; or
an ACK, from the second network node or the third network node, indicative that the fourth network node successfully received the second information.

9. The first network node of claim 1, wherein the at least one processor is configured to:
receive, from the second network node or the third network node, a NACK indicative that the fourth network node unsuccessfully received the second information; and
perform, based on the NACK, one of:
transmitting or retransmitting the second information to the second network node;
retransmitting the second information to the third network node;
transmitting the second information to the fourth network node; or
relying upon the third network node to retransmit the second information to the fourth network node.

10. The first network node of claim 1, wherein the first network node is a base station, wherein the second network node includes an electromagnetic radiation reflective surface, wherein the third network node is a first user equipment (UE), and the fourth network node is a second UE.

11. A first network node for wireless communication, comprising:
a memory; and
at least one processor coupled to the memory, wherein the at least one processor is configured to:
perform a beam training procedure with a second network node, a third network node including an electromagnetic radiation reflective surface, and a fourth network node, wherein the first network node is configured to provide a buffering relay service between the second network node and the fourth network node;
receive, based on the beam training procedure, a first beam including a first communication from the second network node, wherein the first communication includes first information and second information, wherein the first beam is associated with the first information, and wherein the first information corresponds to an operational state of the first network node and an operational state of the third network node; and
provide the buffering relay service, wherein, to provide the buffering relay service, the at least one processor is configured to:
transmit the second information to the fourth network node;
receive, from the fourth network node, feedback information indicative of whether the fourth network node unsuccessfully or successfully received the second information; and
transmit the feedback information to the second network node.

12. The first network node of claim 11, wherein the second information includes a transport block.

13. The first network node of claim 11, wherein the first information is a beam training identifier (ID).

14. The first network node of claim 11, wherein the first information includes information indicative of the operational state of the first network node and the operational state of the third network node and wherein the operational state of the third network node corresponds to whether the third network node is configured to provide an electromagnetic radiation reflection relay service, and wherein the operational state of the first network node corresponds to whether the first network node is configured to provide the buffering relay service.

15. The first network node of claim 11, wherein the buffering relay service includes a decode-and-forward relay service, and wherein the feedback information includes one of an acknowledgement (ACK) indicative that the fourth network node successfully received the second information or a negative acknowledgment (NACK) indicative that the fourth network node unsuccessfully received the second information.

16. The first network node of claim 11, wherein the buffering relay service includes an amplify-and-forward relay service, and wherein the feedback information includes an indication of whether a signal characteristic associated with the second information received at the fourth network node meets a threshold value.

17. The first network node of claim 11, wherein, to transmit the second information to the fourth network node, the at least one processor is configured to:
transmit the first communication to the fourth network node; or
transmit the second information without the first information to the fourth network node.

18. The first network node of claim 11, wherein, to perform the beam training procedure, the at least one processor is configured to:
receive a plurality of training beams from the second network node, wherein the plurality of training beams includes a first training beam; and
associate the first information with the first training beam, wherein the first beam is associated with the first training beam.

19. The first network node of claim 11, wherein the feedback information is indicative that the fourth network node unsuccessfully received the second information, and wherein, to provide the buffering relay service, the at least one processor is configured to:
receive, from the second network node, a second instance of the second information; and
transmit the second instance of the second information to the fourth network node.

20. The first network node of claim 19, wherein:
to receive the second instance of the second information, the at least one processor is configured to receive a second communication including the second information and one of the first information or third information; and
to transmit the second instance of the second information to the fourth network node, the at least one processor is configured to:
transmit the second communication to the fourth network node; or
transmit the second information without the first information or the third information to the fourth network node.

21. The first network node of claim 20, wherein at least one of:
the first information includes information indicative of the operational state of the first network node and the operational state of the third network node;
the first information is a first ID;
the first ID is a first beam training ID;
the third information is different from the first information and the third information includes the information indicative of the operational state of the first network node and the operational state of the third network node;
the third information is a second ID; or
the second ID is a second beam training ID.

22. The first network node of claim 11, wherein the feedback information is indicative that the fourth network node unsuccessfully received the second information, and wherein, to provide the buffering relay service, the at least one processor is configured to:
retransmit the second information to the fourth network node.

23. The first network node of claim 11, wherein the first network node is a first user equipment (UE), wherein the second network node is a base station, wherein the third network node includes the electromagnetic radiation reflective surface, and the fourth network node is a second UE.

24. A first network node for wireless communication, comprising:
a memory;
an electromagnetic radiation reflective surface; and
at least one processor coupled to the memory and the electromagnetic radiation reflective surface, wherein the at least one processor is configured to:
cause the first network node to perform a beam training procedure with a second network node, a third network node configurable to provide a buffering relay service between the second network node and a fourth network node, and the fourth network node; and
cause the first network node to provide an electromagnetic radiation reflection relay service between the second network node and the fourth network node, wherein, to cause the first network node to provide the electromagnetic radiation reflection relay service, the at least one processor is configured to configure, based on the beam training procedure, the electromagnetic radiation reflective surface to reflect a first beam from the second network node to the fourth network node, wherein the first beam includes a first communication including first information and second information, wherein the first beam is associated with the first information, wherein the second information is destined for the fourth network node, and wherein the first information corresponds to an operational state of the first network node and an operational state of the third network node.

25. The first network node of claim 24, wherein the second information includes a transport block.

26. The first network node of claim 24, wherein, to cause the first network node to provide the electromagnetic radiation reflection relay service, the at least one processor is configured to configure the electromagnetic radiation reflective surface to reflect feedback information from the fourth network node to the second network node, wherein the feedback information is indicative of whether the fourth network node unsuccessfully or successfully received the second information.

27. The first network node of claim 26, wherein the feedback information includes an acknowledgement (ACK) indicative that the fourth network node successfully received the second information or a negative acknowledgement (NACK) indicative that the fourth network node unsuccessfully received the second information.

28. The first network node of claim 24, wherein the second network node is a base station, wherein the third network node is a first user equipment (UE), and the fourth network node is a second UE, and wherein the operational state of the first network node corresponds to whether the first network node is configured to provide the electromagnetic radiation reflection relay service, and wherein the operational state of the third network node corresponds to whether the third network node is configured to provide the buffering relay service.

29. The first network node of claim 24, wherein, to cause the first network node to perform the beam training procedure, the at least one processor is configured to:
cause the first network node to provide the electromagnetic radiation reflection relay service for a plurality of training beams from the second network node.

30. A method of wireless communication at a first network node, comprising:
performing a beam training procedure with a second network node, a third network node, and a fourth network node, wherein the second network node is configurable to provide an electromagnetic radiation reflection relay service between the first network node and the fourth network node, and wherein the third network node is configurable to provide a buffering relay service between the first network node and the fourth network node; and
transmitting, based on the beam training procedure, at least one of:
a first communication to the second network node using a first beam, wherein the first communication includes first information and second information, wherein the first beam is associated with the first information, wherein the second information is destined for the fourth network node, and wherein the first information corresponds to an operational state of the second network node and an operational state of the third network node; or
a second communication to the third network node using a second beam, wherein the second communication includes the first information and the second information, wherein the second beam is associated with the first information.
